(19) United States
(12) Patent Application Publication
(10) Pub. No.: US 2025/0021464 A1
(43) Pub. Date: Jan. 16, 2025

(54) METHOD AND SYSTEM FOR MULTI-LAYERED AND MULTIFACETED ANALYSIS OF COMPUTER SOFTWARE

(71) Applicant: ObjectSecurity LLC

(72) Inventors: Ulrich LANG, San Diego, CA (US); Reza FATAHI, Encino, CA (US); Brendan WEIBEL, Bellevue, WA (US); Holmes CHUANG, Las Vegas, NV (US)

(73) Assignee: ObjectSecurity LLC, (omitted)

(21) Appl. No.: 18/771,749

(22) Filed: Jul. 12, 2024

Related U.S. Application Data
(60) Provisional application No. 63/526,875, filed on Jul. 14, 2023.

(51) Int. Cl. G06F 11/36

(52) U.S. Cl. CPC G06F 11/3612

(57) ABSTRACT

Method and system for analyzing at least one computing system to determine attributes of software within computing systems, includes: loading input data representing or pertaining to the software of the computing system; loading and executing at least two individual analyses on the data format of the software of the input data; generating an individual analysis result for each of the at least two individual analyses; loading and executing multi-layer/multi-data format analysis on the individual analysis results; generating multi-layer and/or multi-data format analysis result indicating an additional attribute being different from the attributes indicated by the first and second ones of the individual analysis results; generating an output data describing the individual analysis results and/or the multi-layer and/or multi-data format analysis result; storing the output data; and determining if the output data satisfies a predetermined condition, and if so, executing action corresponding to the output data on the computing system.

This application claims priority to U.S. Provisional Application No. 63/526,875 entitled “Method and System for Multi-Layered and Multifaceted Analysis of Computer Software”, which was filed on Jul. 14, 2023, and which is incorporated herein by reference.

This invention was made with government support under HDTRA123P0002 awarded by United States Defense Threat Reduction Agency (DTRA). The government has certain rights in the invention.

### BACKGROUND OF THE INVENTION

### 1. Field of the Invention

This application relates generally, but not exclusively, to a novel method relating to analyzing computing systems, including, but not limited to, software applications developed using No/Low-Code (NLC) systems. More particularly, embodiments of the invention are directed at automatically and semi-automatically analyzing software applications, for example but not limited to detecting weaknesses and vulnerabilities and identifying mitigations. More particularly, embodiments of the invention are directed at improving analysis effectiveness and more intelligent monitoring capabilities by analyzing computing systems using multiple analysis approaches, for example but not limited to binary analysis, software composition analysis, software analysis using AI/ML, behavior analysis, policy analysis etc.—across multiple layers, for example but not limited to NLC, configurations, source code, Intermediate Representation (IR), Intermediate Language (IL), Just-In-Time (JIT) code, machine code, binary code etc.

### 2. Description of the Related Art

### Introduction

Conventional approaches, such as manual code reviews and reactive security measures, fall short in addressing the dynamic nature of modern threats. These techniques are time-consuming, prone to human error, and struggle to keep pace with the evolving threat landscape. Furthermore, specialized tools that focus solely on source code analysis, are insufficient to identify the full spectrum of vulnerabilities and risks that exist within an application.

Multi-layered and multi-faceted analysis is related to cross-layer analysis, which in general can be defined as a technique whereby analysis results in different layers of a subsystem are linked together and co-analyzed. In the context of the present invention, a multi-tiered and multi-layered approach allows for comprehensive vulnerability assessment from various perspectives, including (but not limited to) source code, binary/bytecode products, configurations, policies, and system behavior.

The current state of the art in software security analysis is characterized by specialized tools and methodologies aimed at identifying and mitigating vulnerabilities within different facets of target computing systems. These tools and methodologies generally focus on three main areas: source code analysis, binary analysis, and configuration file analysis. While each area has seen significant advancements, they are often treated as separate domains, leading to fragmented and siloed security efforts. Examples (but not limited to) include:

### 1. Source Code Analysis

Source code analysis tools are designed to scan and evaluate the source code of software applications. These tools, such as static code analyzers and linters, detect potential security flaws by examining the codebase for common vulnerabilities, coding errors, and adherence to security best practices. Modern source code analysis tools employ sophisticated techniques like abstract syntax trees (ASTs) and control flow graphs (CFGs) to provide detailed insights into the code's structure and behavior. Despite their effectiveness, these tools primarily operate within the confines of the source code, lacking the ability to seamlessly integrate insights from other stages of software development.

### 2. Binary Analysis

Binary analysis focuses on examining compiled software binaries to identify security vulnerabilities that may not be apparent in the source code. Techniques such as disassembly, decompilation, and symbolic execution are commonly used to analyze binaries. Binary analysis tools are crucial for detecting issues like buffer overflows, memory corruption, and other runtime vulnerabilities. However, these tools often work in isolation, without leveraging the contextual information available from the source code or configuration files.

### 3. Configuration File Analysis

Configuration file analysis evaluates the security implications of configuration settings and policies that govern the behavior of target computing systems. Misconfigurations can lead to significant security risks, such as unauthorized access, data leakage, and system compromise. Tools for configuration file analysis check for compliance with security standards and best practices, but they typically do not integrate with source code or binary analysis tools, resulting in a disjointed approach to security.

### Gaps in the State of the Art

The primary gap in the current state of the art is the lack of a unified approach that integrates source code analysis, binary analysis, and configuration file analysis into a cohesive framework. This fragmentation leads to several issues:

1. Limited Contextual Understanding: Tools operating in isolation lack the contextual information necessary to fully understand and accurately identify vulnerabilities. For example, a vulnerability detected in a binary file might have its roots in the source code, but without a unified analysis, correlating these insights is challenging.

2. Inefficiency in Vulnerability Detection: The absence of integration leads to redundant efforts and inefficiencies. Security teams must manually correlate findings from different tools, which is time-consuming and prone to errors.

3. Incomplete Security Coverage: Addressing security in silos results in gaps where certain types of vulnerabilities might go undetected. For instance, configuration-related vulnerabilities might not be apparent in the source code or binary analysis alone.

4. Inability to Adapt to Continuous Development: Modern software development practices, such as continuous integration and continuous deployment (CI/CD), require real-time security assessments across all stages of development. The current tools are not well-suited to provide seamless, integrated security checks in such environments.

To address these gaps, the present invention offers a comprehensive analysis system that unifies for example (but not limited to) source code analysis, binary analysis, and configuration file analysis into a single, integrated framework. This analysis system leverages sophisticated data normalization and advanced machine learning techniques to ensure compatibility and seamless interaction between different analysis modules. By providing a cohesive pipeline for security analysis, an analysis system enhances contextual understanding, improves efficiency, and ensures complete security coverage across the entire software lifecycle. An analysis system's adaptability to CI/CD environments ensures that it can provide continuous and real-time security assessments, meeting the demands of modern software development practices. This integrated approach represents a significant advancement in the state of the art, addressing the critical gaps in current methodologies and enhancing the overall security posture of target computing systems.

### SUMMARY OF THE INVENTION

The present analysis system integrates traditionally separate areas of software analysis into a cohesive framework designed to enhance cybersecurity measures in target computing systems. By leveraging for example but not limited to source code analysis, binary analysis, and/or configuration file analysis, an analysis system creates an advanced pipeline capable of identifying and/or mitigating vulnerabilities across various stages of software development and deployment.

Source code analysis components ingest source code directly from the development environment, normalizing the input data and/or generating datasets. These datasets are validated to ensure their integrity and accuracy. Security policy analysis and automation further import for example but not limited to configuration and preference data, processing it to perform for example but not limited to policy analysis, change detection, AI/ML classification, anomaly detection, and/or rules-based analysis. This thorough examination ensures that any potential security vulnerabilities are identified early in the development process.

Binary analysis components focus on examining binary files produced during the build process. Through ingestion and normalization of binary files, an analysis system may enhance for example the quality of binary lifting for analysis. Symbolic execution combined with constraint and solver analysis delves deeply into the binary code, while AI/ML techniques detect anomalies. Context analysis evaluates intermediate representations using specific target configurations to provide comprehensive insights into the binary files' security posture. An analysis system also runs software in a virtualized environment for example to monitor dynamic runtime behaviors, employing various security tests and/or recording data using system monitoring tools.

Configuration file analysis evaluates the security implications of configuration files, ensuring that for example but not limited to security policies and/or potential vulnerabilities are thoroughly analyzed. This module processes configuration data to analyze for example but not limited to security policies, identify vulnerabilities, and/or integrates with CI/CD environments to normalize data. An analysis system processes data through several steps, including for example but not limited to formatting, processing, and analysis, ultimately storing it in a reference anthology. Calibration mechanisms and reinforcement feedback loops enhance for example the accuracy and/or relevance of the analysis by incorporating insights from security analysts.

An analysis system's integration is managed through a configuration API that handles the specification of input and output data formats and pipeline configurations. The API ensures compatibility of data types across modules and defines the order and arrangement of analysis and supporting modules. Dynamic behavioral analysis frameworks, including for example but not limited to calibration mechanisms and/or reinforcement feedback, continuously improve an analysis system's accuracy and adaptability.

The present analysis system excels in its ability to create complex pipelines that integrate various facets of software analysis, thereby offering a comprehensive and/or adaptable approach to cybersecurity. This pipelining capability allows an analysis system to dynamically combine for example but not limited to source code analysis, binary analysis, and/or configuration file analysis in a multitude of configurations, tailored to meet specific security needs.

At its core, an analysis system's flexibility in building pipelines is managed through its configuration API. This API enables the specification of input and output data formats, ensuring that different modules can seamlessly communicate and share data. The API supports a variety of data types, such as for example but not limited to intermediate representations from data structures, security policies, and/or binary lifting, which allows an analysis system to maintain compatibility across diverse analysis tasks.

Analysis modules are the primary components responsible for examining and/or processing data to identify security vulnerabilities. These modules can include for example but not limited to source code analysis components that ingest and normalize source code data, binary analysis components that process and analyze binary files, and/or configuration file analysis components that evaluate security policies and configurations. Each analysis module is designed to perform specific tasks that contribute to the overall security assessment, such as for example but not limited to symbolic execution, AI/ML anomaly detection, and/or policy change detection.

Support modules, on the other hand, provide auxiliary functions that enhance the capabilities of analysis modules. These modules include for example but not limited to data ingestion mechanisms that normalize input data, parsing engines that prepare data for analysis, and/or context analysis tools that evaluate intermediate representations. Support modules ensure that the data fed into analysis modules is correctly formatted and/or enriched with additional context, which improves the accuracy and/or depth of the analysis.

An analysis system can exist in various forms, for example from simple single-module configurations to highly complex multi-module pipelines. A basic form might involve for example a single source code analysis module that ingests and/or analyzes source code for vulnerabilities. In more advanced configurations, an analysis system can for example combine multiple analysis modules in a pipeline, where the output of one module serves as the input for another. For example, a pipeline might start with a source code analysis module, whose output is then fed into a binary analysis module, followed by a configuration file analysis module. This chaining of modules allows an analysis system to perform a comprehensive security assessment that covers all aspects of the software lifecycle.

An analysis system also supports the integration of third-party analysis and/or support modules, which can be incorporated into the pipeline to extend its capabilities further. This is particularly useful in for example continuous integration and continuous deployment (CI/CD) environments, where an analysis system can interact with other tools and/or processes to provide real-time security assessments as software is developed and deployed.

To build complex pipelines, an analysis system uses a pipeline specification API that defines the arrangement and/or order of the analysis and/or support modules. This API allows operators to configure the pipeline through various means, including for example command-line interfaces, graphical user interfaces, and/or natural language processing systems. Operators can specify for example the sequence of modules, the data types to be used, and/or the specific tasks to be performed at each stage of the pipeline. This level of customization ensures that an analysis system can be tailored to meet the unique security requirements of any software project.

Herein are some examples of how the invention may be implemented. Note this list is not exhaustive, and the invention may be created in some other manner similar in function, but not within the example's exact specification. It is therefore an object of the invention to provide some or all of:
Analyzing security policies and configurations: Security policies play a critical role in ensuring the overall security of NLC platforms and/or other application environments. Analyzing security policies is of utmost importance due to their potential impact on the security posture of the system. Misconfigurations or policy violations in this area can lead to disastrous consequences, making it a top priority for analysis.
Binary analysis: Binary analysis can analyze binaries without the need for source code or documentation of the software and can be done for example but not limited to with dynamic, symbolic and/or static analysis approaches. Modeling software as Intermediate Representation and/or Intermediate Language (IR/IL) has tremendous potential for long-term benefits. Modeling software as IR/IL provides for example enhanced compatibility and/or portability by abstracting the complexities of different binary formats and/or architectures into a more uniform and/or analyzable form. This allows tools and techniques to be applied consistently, regardless of the original source or target architecture, which is crucial for comprehensive security analysis in diverse computing environments. It also improves analysis capabilities by making advanced techniques such as symbolic execution and/or static analysis more manageable. The level of abstraction provided by IR/IL allows for more accurate detection of vulnerabilities, such as for example buffer overflows or memory corruption, by focusing on the logical structure of the code rather than its specific binary representation. Furthermore, IR/IL simplifies complex code structures by translating them into a more understandable form. This simplification facilitates the application of various analysis techniques and/or helps identify potential security issues. It also aids in understanding and/or documenting the behavior of complex target computing systems. Additionally, modeling software as IR/IL opens up opportunities for advanced code optimization and/or transformation. Security analysts can apply optimization techniques to the intermediate form to uncover hidden vulnerabilities that might not be apparent in the original binary. This approach not only enhances the immediate analysis capabilities but also contributes to long-term improvements in the security and/or reliability of target computing systems.
AI/ML based analysis (“Software AI”): The utilization of AI/ML allows the invention to learn from data gathered in other analyses modules of the invention, including for example but not limited to detecting anomalies, correlations etc. Furthermore, Large Language Models (LLMs) can be used to analyze for example both source code and/or IR/IL using AI/ML techniques. LLMs can also make the platform interactive, allowing users to for example explain code and/or changes to code using natural language processing. Software AI can improve the holistic and/or complete analysis of applications and/or leverage AI/ML to enhance other modules' results.
Software Composition Analysis (SCA): By modeling software from for example source code and/or IR/IL, the present invention can identify for example data vulnerabilities and/or conduct relationship and similarity queries with graph databases. This provides flexibility and ease of use in detecting vulnerabilities and is well-suited for leveraging AI/ML techniques to further enhance its capabilities.
System behavior analysis: System behavior can comprise a wide variety of dynamic assessment methods, including for example application testing, user interface testing, API testing etc.

The present invention has a number of benefits, including but not limited to:
The Intermediate Representation and/or Intermediate Language (IR/IL) of software applications can be effectively modeled and/or analyzed, yielding for example insights comparable to those obtained from source code analysis.
The adoption of a multi-layered analysis approach can lead to a more holistic and/or comprehensive outcome. By for example designing, developing, testing, and integrating individual modules, the present invention can achieve a synergistic effect in vulnerability detection and system behavior analysis.
A foundational framework capable of analyzing Just-in-Time compiled (JIT′d) languages presents an opportunity to for example effectively analyze and/or assess the security posture of leading No/Low-Code (NLC) platforms and/or frameworks, such as for example Appian and Java.
Integration of advanced AI/ML techniques within the analysis framework can enhance for example the accuracy and/or efficiency of vulnerability detection, system behavior analysis, and/or security policy automation.
The combination of for example but not limited to behavioral analysis, AI/ML analysis, source code analysis, binary analysis, and/or security policy analysis/generation modules can provide a comprehensive and/or effective approach for identifying and/or mitigating data vulnerabilities in for example data-sensitive applications.
The integration and feedback from third-party tools can further enhance the analysis capabilities and/or expand the scope of the design to address a wider range of use cases and scenarios.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. For example, singular or plural use of terms are illustrative only and may include zero, one, or multiple; the use of “may” signifies options; modules, steps and stages can be reordered, present/absent, single or multiple etc.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 depicts an example of the multi-layered and multi-faceted analysis of computer software

FIG. 2 depicts example use case scenarios and examples of the present invention

FIG. 3 depicts a binary analysis example incl. dataset generation of the present invention

FIG. 4 depicts a software composition analysis example of the present invention

FIG. 5 depicts a Software AI analysis example of the present invention

FIG. 6 depicts a behavioral analysis example of the present invention

FIG. 7 depicts a security policy analysis and automation example of the present invention

FIG. 8 depicts a CI/CD amalgamation example of the present invention

FIG. 9 depicts standardizing or modeling inputs and outputs across modules to build sophisticated pipelines

FIG. 10 depicts a unification and analyses of results from various sources for output

FIG. 11 is a pseudocode depiction of a form or function of unifying and/or analyzing the outputs from various modules of the present invention

### DETAILED DESCRIPTION

The words “exemplary” and/or “example” are used herein to mean “serving as an example, instance, and/or illustration.” Any embodiment described herein as “exemplary” and/or “example” is not necessarily to be construed as preferred and/or advantageous over other embodiments. Likewise, the term “embodiments of the invention” does not require that all embodiments of the invention include the discussed feature, advantage and/or mode of operation.

Further, many examples are described in terms of sequences of actions to be performed by, for example, elements of a computing device. It will be recognized that various actions described herein can be performed by specific circuits (e.g., Application Specific Integrated Circuits (ASICs), Field Programmable Gate Arrays (FPGA), Graphics Processing Units (GPU)), by program instructions being executed by one or more processors, and/or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

### Terminology

For this specification, terms and acronyms may be defined as follows:
AI/ML Artificial Intelligence and Machine Learning
API Application Programming Interface
AST Abstract Syntax Tree
BAP Binary Analysis Platform
BERT Bidirectional Encoder Representations from Transformers
CE Appian Community Edition
CFG Control Flow Graph
CI/CD Continuous Integration and/or Continuous Development
CLI Command-Line Interface
CPG Code Property Graphs
CVE Common Vulnerabilities and Exposures
DevSecOps Development, Security, and Operations
DSL Domain Specific Language
FPGA Field Programmable Gate Array
HITL Human-in-the-Loop
IR/IL Intermediate Representation and/or Intermediate Language
JIT Just-in-Time
JSON JavaScript Object Notation
LLM Large Language Model
LORA Low Rank Adaptation
LSTM Long Short-Term Memory
NLC No/Low-Code
NLP Natural Language Processing
ONR Office of Naval Research
POC Proof of Concept
RL Reinforcement Learning
Software AI Term defined by ObjectSecurity. ML-based Software Analysis, similar to ML4Code but not limited to source code
SBFL Spectrum-Based Fault Localization
SBOM Software Bill of Materials
SCA Software Composition Analysis
SDLC Software Development Lifecycle
SDR Software Defined Radio
SOC System-on-Chip
UI/UX User Interface and/or User Experience
VM Virtual Machine

### Multi-Layered and Multifaceted Analysis

The following describes an example of an analysis system that is superior to conventional approaches due to its integration of multiple (in the example below but not limited to: five) distinct elements that allow for comprehensive analysis across a broader set of targets. An example of the platform supports the analysis of various software artifacts, including, but not limited to, source code, binary/bytecode files, assembly code, and/or firmware, covering a wide range of device types and/or architectures. This includes for example Complex Instruction Set Architectures (CISC), Reduced Instruction Set Architectures (RISC), and/or intermediate representations, etc., encompassing for example industrial infrastructure, critical systems, computer applications, mobile applications, and more.

What distinguishes the present invention from conventional approaches is its multi-layer approach to vulnerability analysis through the selection of more than one (for example but not limited to, five) distinct elements and/or perspectives: In an example, including but not limited to security policy configurations, Software Composition Analysis (SCA), ML-based software analysis, binary analysis, function similarity, and/or leveraging behavioral analysis from system data, etc. In this way, an example of the present invention excels in configuration-as-code scenarios, like for example Kubernetes clusters, by analyzing both configuration and/or source code from for example various NLC development platforms, application development environments, and/or third-party binary files, etc., expanding its scope and/or versatility.

The integration of binary analysis addresses the limitations of traditional source code analysis, surpassing existing solutions. By analyzing for example binary and/or bytecode representations, an example of an analysis system uncovers vulnerabilities arising during and/or after compilation processes. This analysis of compiled products' Intermediate Representation (IR) serves as a parallel target for other modules, including, but not limited to, ML-based Software Analysis and/or Software Composition Analysis (SCA), etc.

The ML-based Software Analysis module leverages potentially advanced AI/ML techniques, including for example large language models (LLMs) and/or deep learning techniques, to enhance vulnerability detection, code understanding, interactivity, exploit analysis, and/or explainability. In an example, this module consolidates findings from other modules, resulting in a unified and interpreted report, incorporating various perspectives with support for the addition of future modules and/or reinforcement learning.

Software composition analysis (SCA) advances security assessments by modeling components as data structures. In an example, an analysis system integrates SCA's modeling aspects with the Intermediate Representation (IR) of compiled applications, enhancing modeling, query, and/or analysis capabilities through Control Flow Graph (CFG) analysis from advanced solver and/or constraint methods.

System behavior analysis in DevSecOps measures and/or analyzes the behavior of host machines during dynamic testing. In an example, an analysis system detects abnormal patterns and/or potential security threats by monitoring for example CPU, memory, disk usage, and/or network packet patterns, serving as indirect indicators of bus and/or library usage. By calibrating host behavior under non-vulnerable and/or vulnerable conditions using control applications and/or samples, this module facilitates result analysis and/or the integration of third-party tooling.

The security policy analysis module is critical in, for example, detecting and/or addressing vulnerabilities in an example, an analysis system, for example to detect data-related vulnerabilities such as access rules, policies, and/or configurations, etc. In an example, it plays a pivotal role in NLC platforms and application development environments, where for example configuration-as-code and/or container orchestration frameworks prevail. Analyzing and/or remediating configuration-related vulnerabilities, this module for example ensures robustness and/or security in modern cloud computing architectures, proactively mitigating potential risks.

The following sections describe examples corresponding to the figures presented in this patent. The present invention is composed of multiple modules detailed below:

### Modular Components of Example Analysis System

By adopting a multi-layered and multifaceted approach, the present invention advances security analysis and automation for NLC and/or traditional applications, and increases accuracy, coverage, and/or efficiency.

The present invention extends the limits of conventional security analysis and automation by employing multiple complementary approaches, including but not limited to some or all of the following examples:
Binary Analysis: The present invention may employ advanced techniques to analyze application binaries, including those from NLC sources. By scrutinizing the binary code, an analysis system may detect potential vulnerabilities, identify malicious code, analyze potential paths of exploitation, quantify the likelihood of a vulnerability being exploitable, and/or assess the overall security posture of the application. The ability to capture specific data event-related features, such as logging and/or database connections, by characterizing binary patterns is a particularly desirable aspect of this technique.
Source Code Data Graph-Based Modeling: The present invention may leverage graph-based modeling techniques to visualize the flow of data within applications. This approach may be available for analysis using source code and Intermediate Representation (IR) from disassembled binary files. By structuring data as Abstract Syntax Trees (AST) and/or Code Property Graphs (CPG), the present invention may enable advanced analyses techniques to identify potential vulnerabilities related to data privacy and/or security. This opens possibilities for comprehensive analyses of data-related features, their similarity, and/or grouping.
Software AI Analysis: The present invention may utilize machine learning techniques specific to code analysis (e.g., Software AI) to evaluate source code and/or IR targets. These techniques may identify for example but not limited to patterns and/or anomalies in applications, explain code functionality, generate signatures for feedback, transform code for tasks like auto-repair, dataset generation, and/or guide development processes. By fine-tuning and/or leveraging large pre-trained models such as for example but not limited to CodeBERT, CodeT5, Falcon 40B, and/or others, the present invention may cater to use cases such as source code and/or IR targets.
Behavioral Analysis and System Data Collection: This aspect may focus on collecting and/or analyzing system data from both static and/or dynamic test suites. By studying application behavior and/or its impact on system resources, an analysis system aims to identify anomalous patterns and/or potential vulnerabilities. Behavioral analysis complements code analysis by uncovering hidden vulnerabilities that may not be evident through code inspection alone.
Security Policy Analysis and Automation: This aspect of an analysis system may involve analyzing security policies and/or automating their enforcement within applications, with a particular emphasis on NLC environments. This includes for example identifying deviations from established security standards, detecting misconfigurations, and/or suggesting remediation actions to enhance the overall security posture.

By employing the example modules outlined above, an analysis system approaches analysis from a multi-layered and multifaceted angle. The example modules are designed in a manner to optimally benefit from one another, an analysis system maintains tracking and state parameters useful in reinforcement feedback from for example the analysis results, bottlenecks, performance, etc. for continuous improvement via feedback loop and/or reinforcement mechanisms detailed below. Key benefits of this design are the ability to interoperate under a wide variety of scenarios such as for example but not limited to CI/CD, DevSecOps, Binary Analysis, SBOM Analysis, Continuous Monitoring, and/or other scenarios as they may arise. An analysis system may provide flexible integration with third-party tools, allowing an analysis system to ingest and/or utilize their analysis results. This capability enables an analysis system to view a new perspective on the existing results in customer pipelines, uncovering insights and/or hidden patterns that may have been overlooked before.

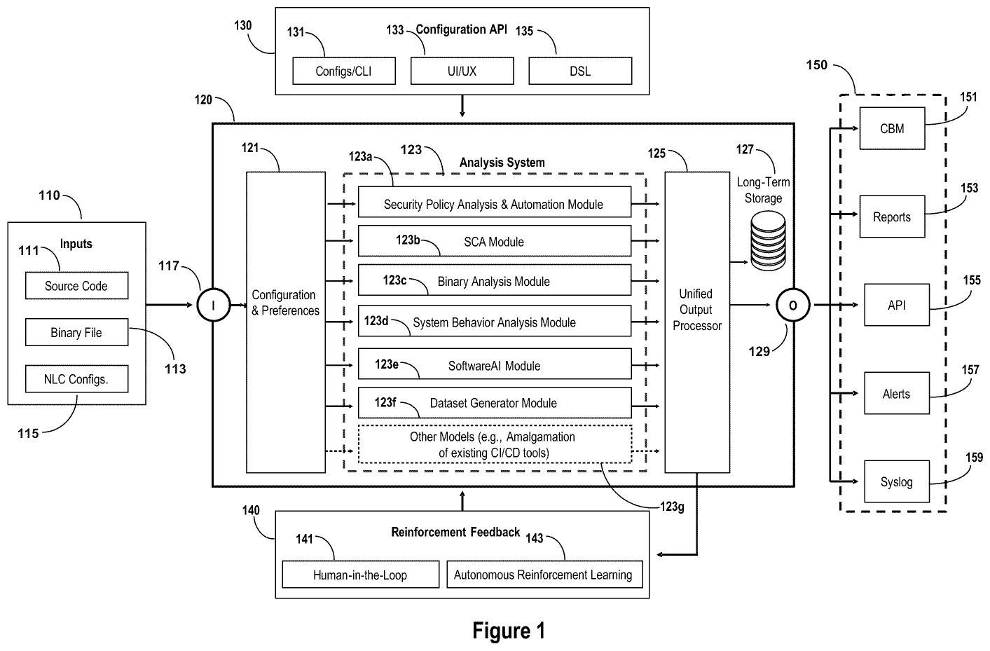

As depicted in FIG. 1, in the present invention, the inputs to an Analysis System (123) may vary and be utilized combinatorically. For example, a CI/CD pipeline may analyze source code then the binary product, or exclusively one or the other. Additional configuration files, for example, the XML files of Appian applications (as an exemplary targeted NLC system), are candidates for input (i.e., combinatorically, or exclusively, depending on the needs and/or preferences of the operator or use case). The constraints, defining what parameters to analyze, report, configuring automated output features, and/or fine-tuning of an Analysis System (123) are provided by various interfaces such as, but not limited to, a UI/UX, CLI, CI/CD plugin, software development kit, API, Configuration-as-Code, DSL, integration into a software analysis tool, etc. The inputs and system constraints may be applied to the analysis of an Analysis System (123), driving the output and/or functionality of the reinforcement mechanism.

The analysis feature of the present invention may be a modular architecture composed of configurations/preferences, multiple analysis modules (detailed below), an output controller, long-term storage of results (i.e., for comparative analysis, auditing logs, modeling, reinforcement, etc.), and/or a reinforcement feedback loop. The reinforcement mechanism may be designed as a HITL (Human-in-the-Loop) and/or autonomous RL (Reinforcement Learning) to improve system performance, allowing fine-tuning of performance, and/or enabling optimized outcomes.

The results of an Analysis System (123) may be outputs that may vary in their form and function. Outputs may be customizable according to the constraints applied to the system. The present form of an Analysis System (123) illustrates a few of the possible outcomes of outputs including Reports (153), automated responses (i.e., through API (155), Condition-Based-Monitoring (CBM) (151), Webhooks, etc.), Alerts (157) (i.e., such as emails, broadcasts, announcements, MMS/SMS/telephony, etc.), and/or interfacing to various other monitoring and/or management (i.e., Command and Control) utilities through syslog (159), etc.

The process of an Analysis System (123) may start with an input from at least one of a selection of set of Inputs (110). The type of input may vary and extend beyond what is depicted in the diagram. In an exemplary form, the input types may be at least one of Source Code (111), Binary File (113), and/or configuration files, such as those for no- and/or low-code environments, etc., depicted as NLC Configs. (115). Input(s) may be acquired by the System (120) of the invention. The input to an Analysis System (123) may be provided through an input Application Program Interface (API), depicted in the diagram as (117). An Analysis System (123) may be configurable to allow an operator to set their intentions, through Configurations and Preferences (121).

Notably, the Configurations and Preferences (121) may be available from an outside source that may be interfaced to the System (120) of the invention. The outside source, in its exemplary form, allows the definition of Configuration API (130), that may otherwise be any type of configuration and/or preference that would affect the performance of the System (120) of the invention. In its exemplary form, the Configuration API (130) are an external source that may be comprised of at least one of a selection of Configurations and or Command Line Interface (131), a User Interface with User Experience (133) such as a Graphical User Interface, and Domain Specific Language (135). The external Configuration API (130) of the invention can be the acquisition of data and/or information that is useful to the analysis of the System (120) and may otherwise consist of other forms not depicted herein such as any API.

Together, the input and the operator-defined intentions are utilized by the System (120) of the invention to drive analysis through an Analysis System (123). This Analysis System (123) is unique in that it covers three broad areas of software that were previously analyzed disparately, namely:
1) Source code, with source code analysis components;
2) Binary files, with binary analysis components, and/or;
3) Configuration files, with associated configuration analysis components.

The present invention enables the logical union of these three pieces of the whole to result in a significant advancement to the state of the art in the cybersecurity of target computing systems.

In its exemplary form, an Analysis System (123) is depicted in a specific and/or preferred form. However, the invention is not intended to be limited in its representation. For example, an Analysis System (123) may be structured to allow different classes of deep neural network analysis systems to be organized. Another form may separate analyses based on their types, such as for example algorithmic, statistical, logical, and/or deep neural networks. The present, exemplary form organizes the components within an Analysis System (123) in an arbitrary manner, wherein the analysis components are organized by for example but not limited to domains of concern across the three, aforementioned broad categories (i.e., source code, binary, configurations) related to target computing systems. These include:
Security Policy Analysis and Automation Module (123a), wherein the configurations are analyzed for access and/or security-related policy rules and related items of a target computing system;
Software Composition Analysis (SCA) Module (123b), wherein source code may be analyzed in various forms to identify potential areas for improvement and/or potential areas where security flaws may be identified;
Binary Analysis Module (123c), wherein a series and/or selection of static, dynamic, and/or hybrid analysis techniques exist to assess security flaws from the analysis of an input binary file and/or binary product of a software's build pipeline;
System Behavior Analysis Module (123d), wherein the analysis of a running system, for example in emulation, simulation, digital twin, and/or equally suitable replacement are running a program under analysis through a series of automations such as but not limited to integration tests;
SoftwareAI Module (123e), wherein deep neural networks specific to the analysis of source code are utilized to analyze source code for potential security flaws and/or vulnerabilities;
Dataset Generator Module (123f), wherein data may be generated and/or captured for feedback to an Analysis System's (123) neural networks, including but not limited to the analysis components comprised of deep neural networks and/or the automated reinforcement mechanism of the invention, and/or;
Other Modules (123g), wherein it is explicitly shown an Analysis System (123) is not limited in its type, quality, number, amount, organization, and/or function of analysis components.

The results of an Analysis Module (123) are aggregated and further analyzed by a Unified Output Processor (125), wherein disparate results from multiple analyses mechanisms may be combined into a logical whole. The internal function of this module is not limited and may comprise any manner of methodologies, including but not limited to statistical, algorithmic, logical, and/or deep neural networks, to arrive at a desirable outcome. The output of a System (120) may be influenced by the operator-defined intentions, quality of the assessments, and/or organization of the analyses, for example where temporal dependencies may exist, among a host of other various conditions.

Here, it is important to note that target computing systems exist in a very diverse ecosystem of operations. Therefore, it is not the intention of the present invention to host an opinionated and/or rigid formation of analyses, and rather, to adapt to the needs of the operator and their use case. It is for these reasons that the quality of the analyses and/or their logical incoherence is not defined in a specific and/or rigid manner.

In its exemplary form, a System (120) of the present invention includes a non-supervised reinforcement mechanism that can automatically fine-tune and/or improve the settings and/or quality of analyses, wherein the results of a Unified Output Processor (125) may be obtained by a Reinforcement Feedback Module (140), comprised of an Autonomous Reinforcement Learning (143) mechanism. This Analysis System (123) may support human oversight through a Human-in-the-Loop (141) components. The results of reinforcement are designed to improve the quality of the results and/or output of the system.

The output of a Unified Output Processor (125) may be stored in Long-Term Storage (127), wherein results may be accessed for the management of the user experience. For example, this type of data management may be useful in deployment scenarios where a multitude of analyses exists, wherein an operator may access previous results to track progress over time, among other scenarios. Ultimately, the result may be Output (129) as a conclusion for consumption elsewhere.

The Output (129) of the invention may be advanced, such as illustrated in its exemplary form, to accommodate advanced notification and/or response scenarios where further human and/or automated actions may be necessary. An Output Handler (150) of the invention in its exemplary form comprises a set of dispatch, protocol and/or strategy mechanisms to result in subsequent actions by a machine and/or human operator. These include:
Condition Based Monitoring (151), wherein machine actions downstream may be automated;
Reports (153), wherein command and control may evaluate and/or processing by advanced Natural Language Processing automations downstream;
API (155), wherein configurable machine actions may be automated;
Alerts (157), wherein humans and/or machines may be notified of results through a broadcast mechanism, protocol, and/or strategy, and/or;
Syslog (159), wherein networked devices may store and/or act upon the results of analysis.

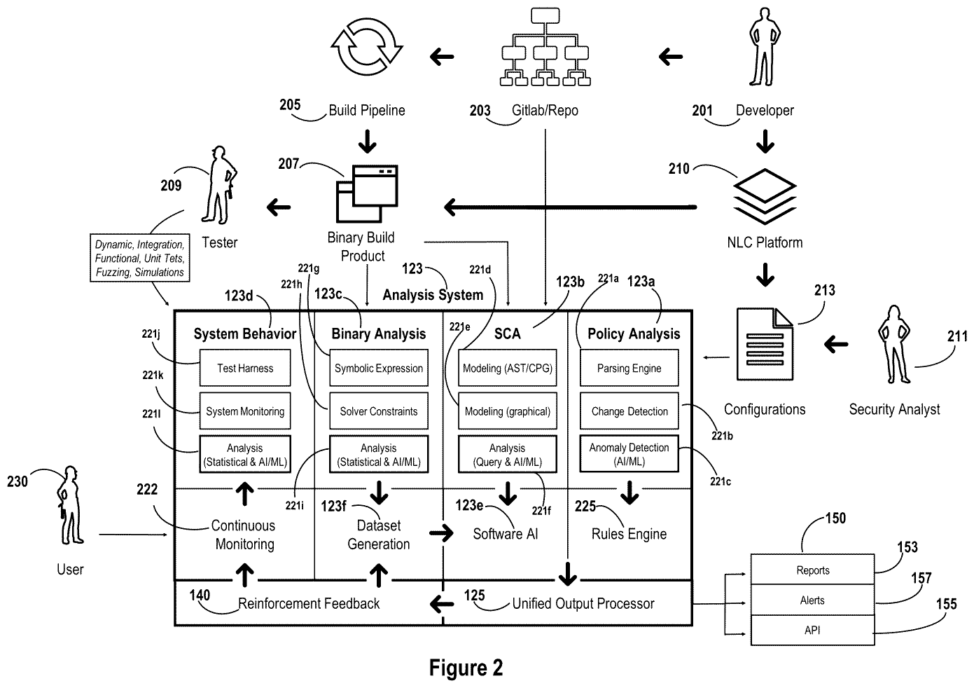

FIG. 2 illustrates examples of how the system may be used as a prototype and/or fielded unit. The final form factor of an analysis system may be designed to fit in a multitude of form factors (e.g., 1U enclosure). In one example, an analysis system may be designed as an embedded component of a production and/or running application utilized by a User (230). This may be made possible with APIs for resource constrained devices (i.e., micro-controllers, embedded devices, etc.) and/or with system integration dependent on the environment it will be hosted on. Therefore, an analysis system may provide feedback for continuous monitoring and/or reporting of vulnerabilities of various applications.

An analysis system may be compatible with various use cases and scenarios, such as DevSecOps and/or CI/CD, wherein a quality control process exists for changes to code bases. In this example scenario, a Developer (201) would configure an analysis system, apply it to their existing infrastructure (i.e., pointing at the source code in a GitLab container/store/repository, for example). In this example scenario, a Developer (201) would configure their desired outcomes. In the example above, the results of the analysis precondition an automated build pipeline (i.e., with Jenkins, for example). A Developer (201) may have access to an interactive console to communicate about changes and/or analysis results with natural language and/or access reports. Other examples may include a Security Analyst (211) analyzing their policies and/or those configured by others for potential vulnerabilities and/or a Tester undertaking dynamic, integration, and/or functional tests, whereby the platform can identify potential vulnerabilities based on system data.

An analysis system may be utilized as a binary analysis module, such as for automated red teaming. In this use case, a Security Analyst (211) may interact with the analysis module through a Domain Specific Language (DSL) that they may utilize for custom/advanced configurations. An analysis system may be pointed to a repository of binary files, such as a patch management system, and/or input binary files through various other means, for example OpenAPI, manually, etc. depending on the needs and/or preferences of the operator. An analysis system would analyze the binary files and make outputs available through various means such as Syslog integration and/or reports. An analysis system may analyze changed, new, and/or incoming binary files over a network. An analysis system may analyze binary files in a Cloud environment, such as, but not limited to, data buckets, web archives, websites containing datasets of firmware and/or binaries, etc.

An analysis system's decomposition and analysis capabilities of binary files provide a robust means of identifying potential vulnerabilities including zero-day vulnerabilities. The same principles apply to other types of binary analysis, such as defining the Software Bill of Materials (SBOM) of a closed-source and/or third-party application. An analysis system may enable the analysis of such binary files to characterize the dependencies, components, arrangement, structure, and/or layout of binary files, eligible for analysis and/or exporting as SBOM. An analysis system may build relationships between the dependencies, components, arrangement, structure, and/or layout, etc., of binary files, source code, disassembly, decompilation, and compiler processes, whereby enabling an SBOM to have contextual information across different formats of the same code. Other related examples that are not illustrated in FIG. 2 are version-tracking capabilities, such as defining the difference between versions of a binary file, predicting the order in which binary versions were released, determining vulnerable versions of a binary and when patches were made, auditing changes to the build products of a program, and/or comparing snapshots at specific times, etc. In this manner, an analysis system may be maximally flexible for the analysis of binary files that may be utilized in various means and scenarios, depending on the preferences and/or needs of the operator and operations.

In its exemplary form, an analysis system may be utilized by a multitude of stakeholders, each with their unique role and/or function. Starting with a Developer (201) who develops, maintains, and/or otherwise has access to amendments to a target computing system, they will organize their changes through a Repository Management System (203) such as but not limited to Gitlab, GitHub, BitBucket, etc., wherein such a system may intrinsically and/or extrinsically support a Build Pipeline (205), as is common in modern software development practices, resulting in the formation of a Binary Build Product (207) to run for analysis. Therefore, in its exemplary form, an analysis system may be supporting the software source code, binary build product, and/or binary input, in combination as a use-case scenario flow as depicted in the diagram, or otherwise in any combination, wherein any part of the software may be available for input, not limited to any use-case scenario.

Once a Binary Build Product (207) is available, it may undergo a quality assurance mechanism that potentially involves a Tester (209). In its exemplary form, a Tester (209) and a Binary Build Product (207) interact with the analyses components for assessing and/or evaluating security-related concerns.

In another use-case scenario, a Developer (201) would access a No- and/or Low-Code (NLC) Platform (210) to perform the essence of their work, resulting in a Binary Build Product (207) such as but not limited to an executable, for example representing an application. An NLC Platform (210) and/or otherwise environment of the Developer (201) may include additional Configurations (213). For example, it is common for an NI. (Platform (210) and/or a Repository Management System (203) to have corresponding configurations that may specify security-related features, functionalities, implications, assertions, and/or ramifications, etc. Configurations (213) themselves may be available for input for analysis.

In FIG. 2, the analysis components are illustrated to clarify their organization and interactions, resulting in a conclusion, result, and/or output. There are a multitude of analysis components (123a-d) with support and/or reinforcement mechanisms, analyzing various facets of a target computing system.

Within each analysis module are a series of submodules that support the analysis of a single component. Each analysis may be associated with at least one submodule and/or subcomponent and may be associated with a series of submodules and/or subcomponents to arrive at a conclusion with respect to the role of the individual analysis component. Submodules and/or subcomponents are generally illustrated as (221), in its exemplary form specified as (221a-l).

Configurations (213) are analyzed by a Policy Analysis (123a) component with three subcomponents: a Parsing Engine (221a) that structures and/or normalizes the potentially unstructured input, Change Detection (221b) mechanism that will respond to differences from known and/or cached results, and/or Anomaly Detection (221c) mechanism that applies artificial intelligence and machine learning (AI/ML) to detect potentially faulty, weak, and/or vulnerable configuration states. It is noteworthy that the internal mechanisms of the Policy Analysis are unimportant for the sake of the present invention, in such that the System (120) of the invention is not opinionated to the quality and/or type of the analyses, in so far as it can be integrated and/or potentially enhanced through automated feedback mechanisms. In the case of the Policy Analysis (123a), the analysis and feedback mechanism may relate to a supporting Rules Engine (225) module that binds the intended, advanced functionalities of an analysis system.

The source code from a Repository Management System (203) mechanism and/or Binary Build Product (207) are candidates for analysis by SCA (123b), which itself may be comprised of submodules (221d-f), comprising data structure Modeling (221d) that structures input to a normalized form such as but not limited to Abstract Syntax Trees (ASTs) and/or Code Property Graphs (CPGs), additional advanced Modeling (graphical) (221e) that focuses on relationships between data structure units for analysis, and/or the Analysis (221f) of the module that may utilize logical queries and/or AI/ML. Likewise to the Policy Analysis (123a), the output of this module may interface with a support module for reuse, reinforcement, and/or enhancement of results, which in its exemplary form for SCA (123b) may be a Software AI (123e) module that can benefit from additional analysis to the structured data of SCA (123b).

Another target of a Binary Build Product (207) is Binary Analysis (123c) comprised of various supporting subcomponents (221g-i). In the current exemplary form, Binary Analysis (123c) structures data to Symbolic Expressions (221g) through, for example, a lifting mechanism, accompanied by the generation of Solver Constraints (221h), for Analysis (221i). In this exemplary form, an analysis may be symbolic execution, whose results may be analyzed statistically and/or with AI/ML to form a conclusion. Notably, the intermediate and/or generated data of these operations may be candidates for Dataset Generation (123f), wherein the findings of the analysis can be expressed in more various and/or numerous ways to benefit other pattern detection mechanisms elsewhere. The significant point of this illustration is the flexible arrangement of an analysis module. An analysis module in and of itself is capable of a conclusion. However, more sophisticated pipelines may be arranged to allow dual-use of data for operations elsewhere and/or for enhancing the results of the analysis module.

Multiple layers of supporting modules may be applied flexibly. In its exemplary form, an analysis system may be configured for unification of results through a Unified Output Processor (125) and Reinforcement Feedback (140). There may be a Continuous Monitoring (222) mechanism that watches for changes, notifying actions such as repeating analyses where needed and/or otherwise acting upon a live, dynamic environment through a feedback loop. This may be especially true in situations where a User (230) makes changes to a live, dynamic system. The result of this feedback action from a Continuous Monitoring (222) unit may be a propagation of updates and/or upgrades to previous analyses and/or previous states of a System (120) of the invention.

In its exemplary form, a Tester (209) of the quality assurance process of an organization will interact with a System Behavior (123d) analysis through a selection of analysis options to run in for example emulation, simulation, digital twin, and/or equally effective manner. These may be dynamic methodologies that include but are not limited to integration tests, functional tests, unit tests, fuzzing, emulation, and/or simulation use cases. The exemplary form of the System Behavior (123d), comprised of a set of at least one subcomponents, is illustrated with a Test Harness (221j), a System Monitoring (221k) subcomponent, and an Analysis (2211) subcomponent. The exemplary form of the selection and organization of the subcomponents of this analysis are not intended to be limit the various forms, organizations, functions, and/or features that the System Behavior (123d) analysis may have.

The remaining explanation of the present invention details examples of specific mechanisms and features:

### Binary Analysis Module

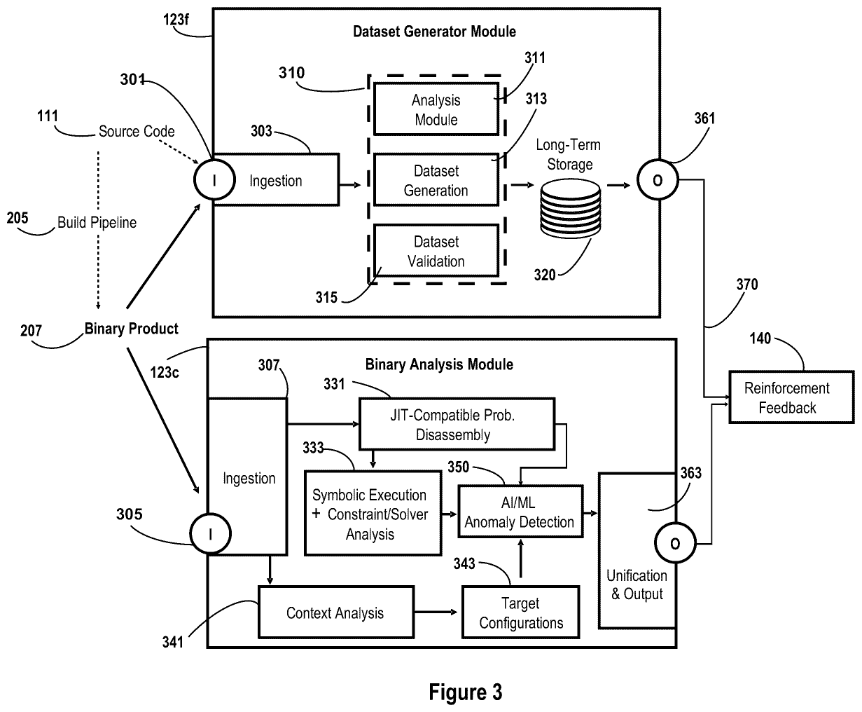

As depicted in FIG. 3, one aspect of the present invention may be binary analysis, which uses techniques to scrutinize application binaries, including those from NLC sources. By examining the binary code, an analysis system can identify potential weaknesses, vulnerabilities, and/or exploits, detect malicious code, and/or assess the overall security posture of the application that may have otherwise been missed by source code analysis, and/or that applies to many various languages and/or frameworks by normalizing analysis to an Intermediate Representation (IR). This approach goes beyond mere static analysis, as an analysis system can capture specific event-related features such as logging and database connections, enabling a deeper understanding of data privacy and/or security.

In this module, a Binary Product (207) may be the result of the compiled Source Code (111). A Dataset Generator Module (123f) may accept Source Code (111) and/or Binary Product (207) as input to generate variants in the expression of software. The result may be an anthology of reference values available for lookup and/or reinforcement for binary analysis and/or other modules.

A Binary Analysis Module (123c) ingests a Binary Product (207) of an application and proceeds with JIT-Compatible Probabilistic Disassembly, combined with generated datasets, AI ML. Anomaly Detection (350), and/or Reinforcement Feedback (140), and/or includes capabilities to analyze Context (341) and/or Targeted Configurations (343) operations with a DSL that will contribute to vulnerabilities detection.

FIG. 3 is an example detailed representation of how various analysis modules may be organized with their corresponding subcomponents, and how these analysis modules may interact with one another. The exemplary form of FIG. 3 is but one depiction that contains broad principles and general characteristics that may apply to various other analysis modules. Although the figure shows two analysis modules, the present invention is not limited in the number and/or organization of the analysis modules.

In its exemplary form, Source Code (111) may be eligible for direct input to a Dataset Generator (123f) module. This module may contain its own ingress API (301) and an associated Ingestion (303) mechanism. Generally, input to a module will consist of an API and/or a mechanism, whereby input data may be normalized to some intermediate representation. Within the Dataset Generator (123f), there may be a collection of Submodules (310) comprised of: Analysis Module (311), Data Generation (313), and/or Dataset Validation (315). The Dataset Generator (123f) is unique in that it may not necessarily perform security-related analysis, but rather act as a supporting module to generate data for use by other modules that may include security-related analysis. The output of this module may be the creation, expansion, and/or enhancement of datasets derived elsewhere. In this case, the data may be coming directly from the Source Code (111). However, the data may come from the product of a Build Pipeline (205), which may be a Binary Product (207). Although not illustrated, the input may come from another module. The submodules result in datasets that may be stored in Long-Term Storage (320) and may be available for output by the module through a dedicated Output API (361). The output module of the Dataset Generator (123f) may be available for direct use by external components, including a Reinforcement Feedback (140).

Another analysis module, the Binary Analysis Module (123c), acquires a binary file, in this case, the Binary Product (207), through a dedicated Input API (305). There may be an associated Ingestion (307) mechanism whereby the input may be normalized to an intermediate representation. In binary analysis, it is common to represent binary in intermediate representation through a process called lifting. The subcomponents of this module can exist in various forms relating to the various types, functions, and/or capabilities of binary analysis, which is a vast field, generally comprised of static, dynamic, and/or hybrid methodologies. The present exemplary form illustrates one specific and arbitrary example of how the subcomponents may be arranged and is not intended to be limited to this arrangement. There may be a JIT-Compatible Probabilistic Disassembly (331) mechanism whereby the quality of lifting may be enhanced for analysis via Symbolic Execution with Constraint and Solver Analysis (333). The output of this binary analysis operation may be available for output and/or additional layers of reasoning and/or analysis. In the present exemplary form, the output of the symbolic execution may be processed by an additional layer of deep learning through an AI MI. Anomaly Detection (350) mechanism. The intermediate representation may be available for Context Analysis (341), whereby heuristic rules specified through Target Configurations (343) may be available for direct analysis such as with the AI MI. Anomaly Detection (350) mechanism. The outputs from the subcomponents in this exemplary form may be sent to a Unification and Output (363) mechanism that may be dedicated to the Binary Analysis (123c) module. This output may be available for feedback globally via the Reinforcement Feedback (140) mechanism.

### SCA Module

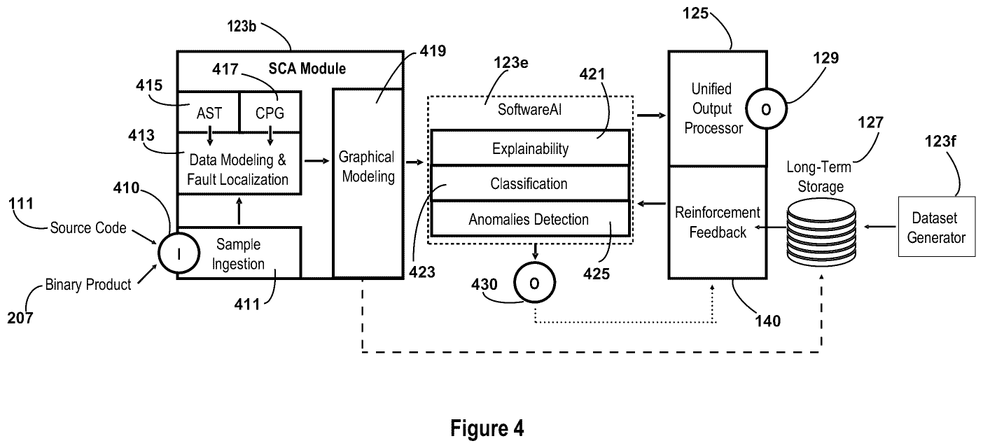

As depicted in FIG. 4, an analysis system may utilize Software Composition Analysis (SCA) (123b) with data modeling, including graphical modeling, to implement advanced capabilities for visualizing the flow of data within applications. This approach, applicable to both source code and/or IR/IL from disassembled binary files, may enable an analysis system to identify vulnerabilities related to data handling, privacy, and/or security. By structuring data as Abstract Syntax Trees (AST) (415) and/or Code Property Graphs (CPG) (417), an analysis system can unlock advanced analyses of data-related features, similarities, and/or groupings.

FIG. 4 outlines an example of the SCA module (123b). An SCA module (123b) may be output vulnerability analysis reports and/or alerts if requested once source code is processed. The approach may be for example have support for both source code, binary and/or bytecode products for the ingestion process to route the input data to AST (415) and/or (PG (417) modeling. The modeled software data may be processed for vulnerability scanning and/or analysis in a vector database with Graphical Modeling (419). The data can then be eligible for a pipeline of analyses based on ML assessments and models that may be optimized for detecting vulnerability patterns under the state of relationships and/or specialized data structures utilized in SCA (123b). This process may be under Reinforcement Feedback (140) using Long-Term Storage (127) including data from Graphical Modeling (419) and/or a Dataset Generator (123f). The results may be organized in a reporting pre-processing submodule for export to operators and/or other services that may be dedicated to aggregating results and/or providing a holistic report, relative to other modules.

FIG. 4 represents a pipelining of multiple analyses within the present invention. A software composition analysis SCA (123b) module may acquire input data from Source Code (111) and/or a binary file such as the Binary Product (207) through a dedicated Input API (410), which may be associated with an Ingestion (411) mechanism for converting the data into a normalized form. The processing by the other subcomponents in this exemplary form is but one form of how software composition analysis may exist, and the present exemplary form is not intended to be limiting. In its exemplary form, there may be a Data Modeling and Fault Localization (413) subcomponent, whereby structuring data to abstract syntax trees AST's (415) and/or code property graphs CPGs (417) results in intermediate representation that can be further modeled, such as by relationships with Graphical Modeling (419). The figure shows that the output of the SCA (123b) module is output to another analysis module, the Software AI (123e). The subcomponents of the Software AI (123e) include mechanisms for Explainability (421), Classification (423), and/or Anomalies Detection (425). In this two-step pipeline, the output from the Software AI (123e) occurs via a dedicated Output API (430) that may be sent to a global output processing unit comprised of a Unified Output Processor (125) mechanism and/or an associated global Output API (129). There may be Reinforcement Feedback (140) that feeds back to the one or more analysis modules. Additional analysis modules and/or supporting modules may exist, such as the existence of Long-Term Storage (127) to support mechanisms such as Reinforcement Feedback (140), and whereby other supporting modules may benefit, such as a Dataset Generator module (123f).

### Software AI Module

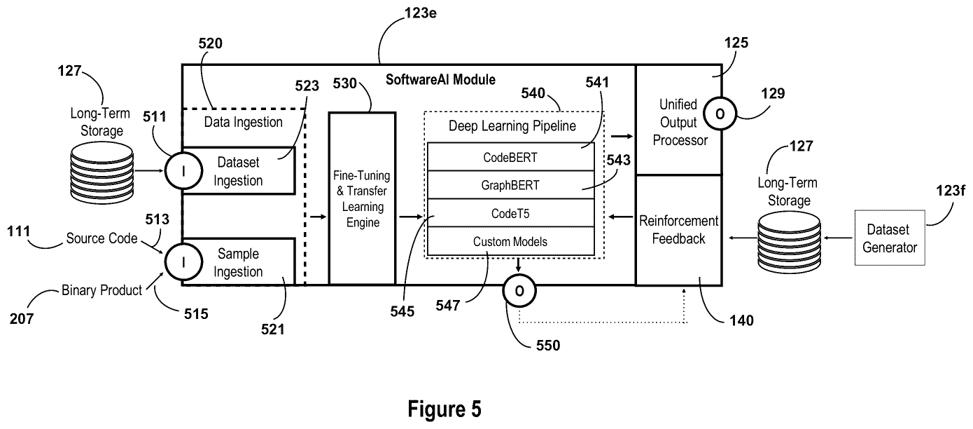

As depicted in FIG. 5, to further enhance its capabilities, the example analysis system may leverage Software AI analysis, utilizing machine learning techniques tailored for code analysis. By leveraging models such as, but not limited to, CodeBERT, CodeT5, Falcon 40B, and/or others, an analysis system may identify patterns, anomalies, and/or potential weaknesses, exploits, and/or vulnerabilities in source code and/or IR targets. An analysis system may facilitate for example code explanation, signature generation, auto-repair, dataset generation, and/or development process guidance, etc., offering unparalleled insights into application security with natural language.

The exemplary Software AI Module (123e) takes in the inputted data, for example, from a dataset that may be previously generated, the current code, and/or binary product that is being probed. The module then ingests and uses the data, allowing the dataset to be transformed into different forms that may be usable in other parts of the module. This ingestion is an important part of the Software AI Module (123e), as the dataset may need to be transformed to be compatible with the various different ML models. This data may be fed through a Fine-Tuning Engine (530), which further processes the data, and prepares the data to allow for both training and/or inference on the ML models. This can include processing the ML models for training using technology such as LoRA to further increase speed of training for the ML models. Long-Term Storage (127) used as the training data may then be fed to the ML models for analysis in the Deep Learning Pipeline (540), including CodeBERT, GraphBERT, CodeT5, and/or any other ML model that will be created. Once these models are trained and fine-tuned from a Fine-Tuning Engine (530), the sample data may be run against the ML models, providing effective output and/or analysis. This data may be put into a reporting system, which consolidates the ML results, and/or transforms the outputted data into actionable information for the end user. Finally, the output and/or feedback from end users may be consolidated and used to train the ML models using Reinforcement Feedback (140).

FIG. 5 illustrates another exemplary form of a Software AI (123e) module, and how an analysis module may function variously based on different types of inputs, depending on its configurations in the pipeline. In its exemplary form, there may be a Long-Term Storage (127) whereby data may be input through a dedicated Input API (511) that expects the data types of the long-term storage mechanism. An associated Dataset Ingestion (523) mechanism exists to normalize the data from the input. Other data sources such as for example Source Code (111) and/or Binary Product (207) may be available through inputs through their processes, which may be shared, or as illustrated in its exemplary form, dedicated for Source Code Input (513) and/or Binary Product Input (515), where a dedicated Sample Ingestion (521) mechanism exists to normalize the input data. Altogether, an Input API (511) and ingestion normalization mechanisms may be structured under a generalized Data Ingestion (520). The normalized data may be available for various tasks, in this case, a Fine-Tuning and Transfer Learning Engine (530), whereby enhancements to various deep learning models exist within a Deep Learning Pipeline (540). In this exemplary form, a Deep Learning Pipeline (540) may be comprised of a set of at least one deep learning model, such as but not limited to CodeBERT (541), GraphBERT (543), Code T5 (545), and/or other Custom Models (547). There may be a dedicated Output API (550) that sends the output for global output via the Unified Output Processor (125) mechanism and/or global Output API (129). In its exemplary form, there may be a Reinforcement Feedback (140) module that feeds back to a Deep Learning Pipeline (540), and which may be augmented by Long-Term Storage (127) that may be enhanced by a supportive module, the Dataset Generator (123f).

### Behavioral Analysis Module

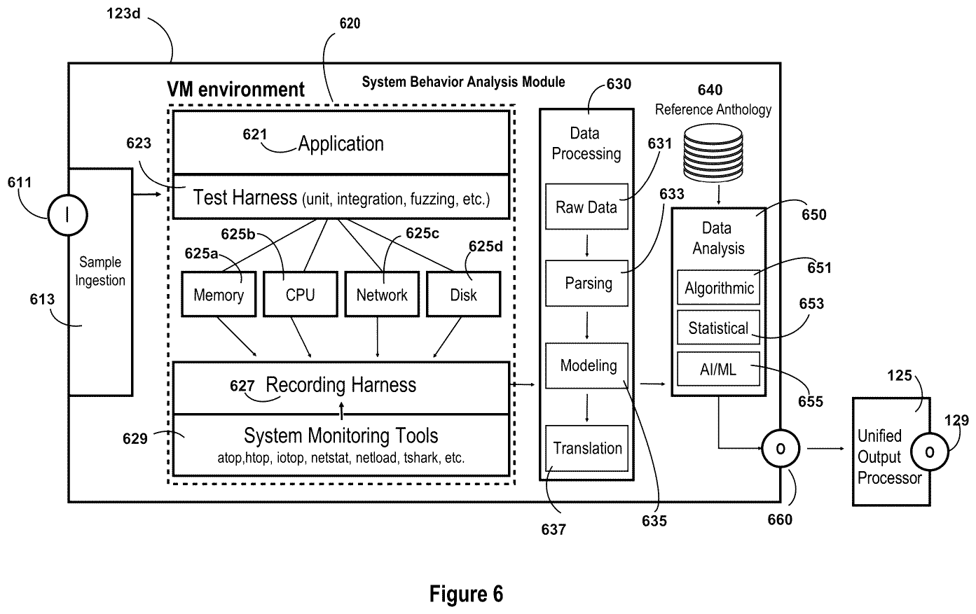

As depicted in FIG. 6, an example of an analysis system utilizes behavioral analysis and system data collection, which can play a pivotal role in understanding application behavior and/or its impact on system resources. By studying system data from static and/or dynamic test suites, an analysis system can uncover hidden vulnerabilities and/or anomalies that might elude traditional code analysis techniques. This approach can provide a comprehensive assessment of application security by combining behavioral and/or code-based analyses.

In the System Behavioral Analysis Module (123d) example, a dedicated VM environment normalizes running/active processes and the system behavior of the environment running the application. This module requires at least one Application (621) that may be configured and/or interfaced to at least one test. The test may be dynamic, however, static tests such as for example SpecFlow/Cucumber may be utilized. Enhanced tests would be similar to fuzzers and dynamic integration tests, such as ML-driven Selenium testing, whereby tests may be both long running and/or comprehensive in their coverage and/or targeting.

An objective of behavioral analysis may be to measure system behavior during an application that may be running. An analysis system parameters that may be eligible for analysis include for example Memory (625a), (PI) (625b), Network (625c), and/or Disk (625d) utilization, among others. This can be enhanced by measures with greater observability, for example, by running the behavioral analysis in FPGA and/or custom ISA with enhanced observability features, JTAG, etc. In general, a tool responsible for recording system behavior will be a system monitoring tool and a collection of these may be utilized for the purposes of acquiring data for analysis. The recorded data may be available for analysis through various pre-processing and/or (i.e., statistical, algorithmic, etc.) analysis techniques.

A necessary hallmark for security analysis of target computing systems is the ability to run target computing systems dynamically in as close to their native environment and/or behavior as possible. This has led to the emergence of advanced emulators, simulators, and/or digital twins. These are often virtualized environments; however, they may be hardware and/or hybrid systems, such as field-programmable gate arrays (FPGAs).

FIG. 6 illustrates a System Behavior Analysis Module (123d), whereby various human-driven and/or automated testing of live, dynamic runtime behaviors of a target computing system may be evaluated. This module generally comprises an input system, comprised of an Input API (611) and/or a Sample Ingestion (613) mechanism whereby data may be normalized. The data can come from a variety of sources, especially target computing systems, such as for example software source code, binary products, and/or configuration data. The normalized data may then be run within a VM Environment (620) that hosts an Application (621) and/or a Test Harness (623). A Test Harness (623) may be where various security-related tests and/or assessments, such as unit tests, integration tests, and/or fuzzing, etc., exist. These will be used to drive the running of a program, whereby monitoring of Memory (625a), (PI) (625b), Network (625c), and/or Disk (625d) resource utilization may be monitored for evaluating security concerns. In its exemplary form, there may be a Recording Harness (627). The data that may be recorded may be derived from System Monitoring Tools (629) that can monitor the various performance utilization aspects of a computer system.

A dynamic behavioral analysis system such as this will often comprise multiple modalities, such as outlined in (625a) through (625d) and may require advanced data processing needs. Therefore, a Data Processing (630) submodule processes data from the recorded raw data (631) that may be parsed with a Parsing (633) mechanism, modeled according to their attributes with a Modeling (635) subcomponent, and/or translated to an intermediate form with a Translation (637) mechanism. In its exemplary form, a Reference Anthology (640) contains data of normal and/or abnormal operations that may be useful for pattern matching and/or anomaly detection. These data may be utilized by the Data Analysis (650) submodule that performs analysis with Algorithmic (651), Statistical (653), and/or AI MI. (655) mechanisms. The resulting data may be passed to a dedicated Output API (660). In FIG. 6, a single analysis module outputs to a global Unified Output Processor (125) mechanism with an associated global Output API (129). It is important to note that the illustration is an exemplary form that illustrates one organization of a system emulation, simulation, and/or digital twin mechanism that can exist in many other forms. There may be other analysis and/or supporting modules that are not included for the sake of clearly demonstrating the various forms a single analysis module may exist. For instance, the Reinforcement Feedback (140) is not illustrated; however, it can be included to provide feedback to the system to improve system behavior analysis in an automated and/or semi-automated manner.

### Security Policy Analysis and Automation Module

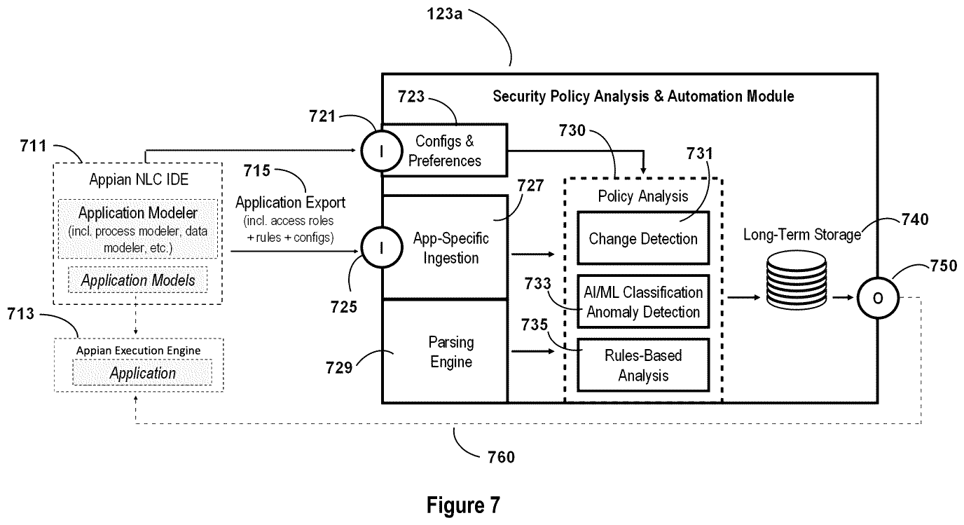

As depicted in FIG. 7, in an example, an analysis system interfaces with NLC configurations during the development and/or testing process. An NLC IDE (711) with the application modeler (incl. process modeler, data modeler, etc.) may be used by the developer(s) to create application models (e.g., Appian) result in model, configuration, and/or metadata files that may be eligible for analysis. An NLC execution engine executes the application based on the application model and/or configuration files.

This example module can be utilized in various settings incl. CI/CD and/or DevSecOps pipeline tooling (e.g., Jenkins, GitLab, etc.), and/or an analysis system's main analysis application, etc. An analysis system may be fed an application export (e.g., Appian ZIP) and/or may obtain the equivalent from a CI/CD repo, etc. The Application-Specific Ingestion (727) processes the application, incl. specification files (e.g., Appian's XML files), to produce a form that can be stored in the App Data Store.

A number of analysis modules may be executed on the data, including rules-based analysis (to determine for example that certain security properties are met), AI/ML based anomaly detection (e.g., deviations from a known baseline and/or detection of outliers), and/or change detection (based on the previous build, and/or based on a known good baseline etc.), etc. The results of the analyses may be stored back in the App Data Store. The system allows flexible addition of analysis modules.

The Results Analyzer assesses all results from the individual analyses and determines how to proceed, such as allowing and/or blocking (if security discrepancies have been identified) the build process, creating alerts/alarms, providing alerts to a Security Operations Center (SOC), etc. It may feed its results back into the App Data Store, and then triggers the Report Pre-Processor, which leads to the generation of a security (and/or compliance) report about the current build.

A user interface, which may be standalone (e.g., web interface), and/or can be a CI/CD plugin (e.g., Jenkins plugin), may allow security professionals to interact with an analysis system: It may allow to set configurations and/or preferences, such as defining rules/configurations for analyses, alert/alarm trigger conditions and/or actions etc. It may allow to view the generated report, and/or—if needed—manually intervene in the build process to allow and/or block a build. It may allow to determine whether identified anomalies are benign and/or should be added to the known good baseline for future builds.

An analysis system can for example (but not limited to) analyze the following from NLC applications:
role and/or rule configurations for developer access to NLC app development (role/role map tags etc.);
record-level security rules and/or features for data access; and/or
security rules and/or features for process model access.

Analysis includes:
algorithmic/rules-based security properties analysis;
machine learning based anomalies detection;
differential calculation to detect deviations from a known good baseline; and/or
information flow analysis (application internal and/or external) from process models.

An analysis system for example documents (reports and/or GUI) and/or produces alerts.

An analysis system for example automatically triggers analysis and/or documentation during CI/CD, and/or block the build if security alerts may be triggered.

Contemporary software composition analysis and/or binary analysis methodologies often overlook configuration-based software policy-related security concerns. The present invention advances the state of the art by incorporating this often-overlooked yet fundamentally critical aspect of target computing systems within a holistic system. FIG. 7 shows a Security Policy Analysis and Automation Module (123a) operating in isolation. Therefore, an analysis system of the present invention can function on a single analysis module such as the security policy analysis, yet it is flexible and may be combined with other aspects of target computing systems through incorporating additional analysis and/or supporting modules in various combinations through dedicated and/or custom pipelines.

FIG. 7 shows an example of a popular leading no-code editor known as an Appian NLC IDE (711), which may be comprised of an application modeler and/or application models that may be available for export through an Application Export (715) mechanism. Normally, the application subcomponents of the Appian system may be executed by an Appian Execution Engine (713). This mechanism may be useful for evaluating changes to security policies and how they relate to the application of the target computing system. The configurations and/or policies of the Appian system may be input through a dedicated Input API (721) with a Configurations and Preferences (723) mechanism that may be utilized to parse and/or normalize the data for analysis through other submodules of a Security Policy Analysis and Automation Module (123a). The application itself may be available to be acquired through a dedicated application Input API (725) with its associated App-Specific Ingestion (727), whereby data may be normalized, such as by a Parsing Engine (729). Altogether, the configurations and/or application data may be sent to a Policy Analysis (730) component where they may be analyzed. There may be a Change Detection (731) subcomponent that analyzes and/or handles differences from previous assessments to avoid repeated procedures and/or enhance performance. There may be a deep learning AI MI. Classification Anomaly Detection (733) subcomponent that may be used for identifying security vulnerabilities and there may be a heuristic Rules-Based Analysis (735) subcomponent that offers a logical and/or algorithmic basis for identifying potential security vulnerabilities. The results of the data may be output to a Long-Term Storage (740) mechanism and/or submodule prior to output from an Output-specific API (750).

### Additional Modules

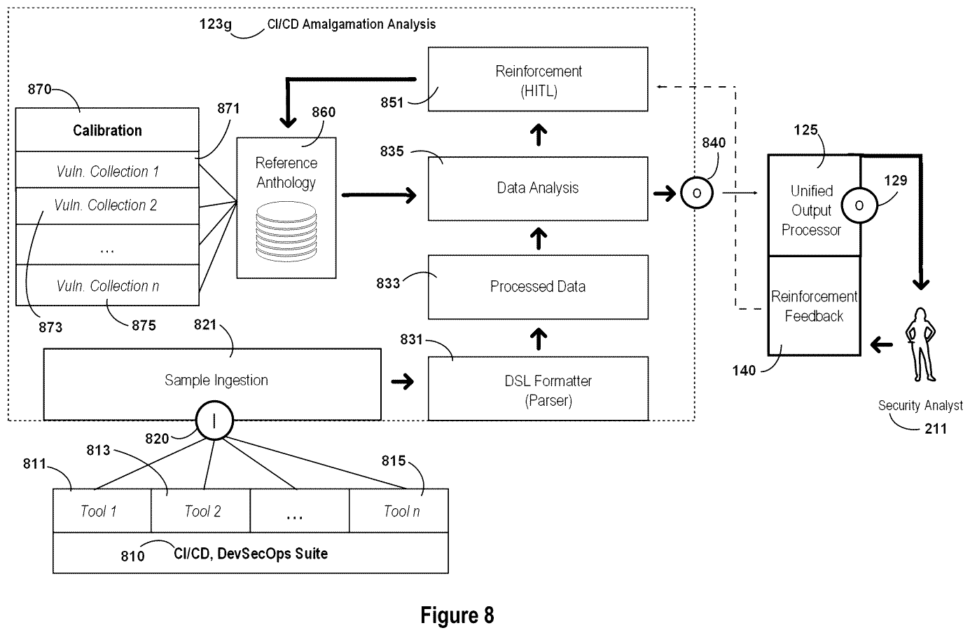

As depicted in FIG. 8, an example aspect of the design of the system may be its ability to be upgraded with other modules and/or enhancements to modules. FIG. 8 depicts an overview of an example module that calibrates to existing toolchains in CI/CD and/or DevSecOps environments with a set of control applications that may be representative of the applications that may be targets for exploitation. The calibration data may be derived and/or contributed to by the dataset generation and/or long-term storage of the system. A Domain Specific Language (DSL) exists to conveniently expand the list of parsers for specific tools. The module includes parsers for the most popular and/or relevant tools.

The raw data derived from each of the tools in the existing CI/CD and/or DevSecOps Suite may be parsed by the selection of a novel parser and/or automated matching of an existing parser. The result may be processed data that may be eligible for analysis (incl. correlation between multiple tool outputs) and/or vulnerabilities detection, including consolidated reporting and/or output. The module may include support for Reinforcement Feedback (140) incl. Human-in-the-Loop feedback from the system's reinforcement feedback system, and/or AI-based feedback, etc.

The CI/CD Amalgamation Analysis (123g) module is an example of a candidate module for expanding system capabilities and features.

FIG. 8 emphasizes the chaining of analysis modules as inputs to one another, demonstrating the ability of the present invention to form highly advanced and/or sophisticated analysis module pipelines. A sample analysis module, a continuous integration and/or continuous development CI/CD Amalgamation Analysis (123g), is demonstrated to have a module-specific Input API (820). This Input API (820) acquires input from various other analysis modules identified as tools, such as Tool 1 (811), Tool 2 (813), and up to an Arbitrary Number of Tools (815). It is important to note that these may be third-party analysis and/or supporting modules and can come from arbitrary other processes and/or mechanisms, such as a CI/CD DevSecOps Suite Environment (810). Therefore, an analysis system may support a cyber-physical deployment and is not limited to software-only mechanisms. The Sample Ingestion (821) into the analysis module normalizes the data. It is important that the Input API (820) may be aware of the source it may be receiving data from, ensuring that the input data may be compatible with the Sample Ingestion (821) mechanism.

The data available for analysis, in this case, includes a Calibration (870) mechanism that may be comprised of a set of at least one vulnerability collection system that results from formatted and/or processed data through a series of steps following Sample Ingestion (821). These steps may include a Domain-Specific Language Formatter (Parser) (831), Processed Data mechanism (833), and/or Data Analysis (835) subcomponent, where the data may be ultimately stored in a Reference Anthology (860). The Calibration (870) hosts a series of vulnerability collections, such as Vulnerability Collection 1 (871), Vulnerability Collection 2 (873), up to an Arbitrary Number of Vulnerability Collections (875). These may further be augmented by a Human-in-the-Loop Reinforcement mechanism (851) whereby a Security Analyst (211) interacts with a Reinforcement Feedback (140) mechanism to augment Reference Anthology (860) data. The ensuing pattern matching may be utilized by the Data Analysis (835) of the system to make determinations, such as pattern matching and/or vulnerabilities detection. There may be a dedicated Output API (840) that sends data for Unified Output Processor (125) and/or global Output (129).

### Multi-Layered and Multifaceted Analysis

A key aspect of the present invention is that it applies and/or combines more than multifaceted analyses, which may be at multiple layers (for example, in a technology stack). In an example, this multi-layered and multifaceted analysis.

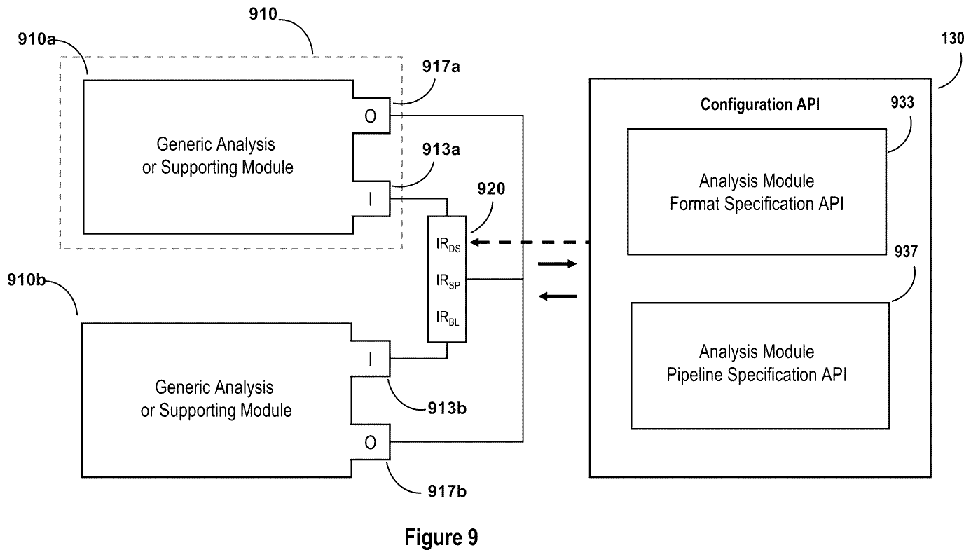

FIG. 9 illustrates how a pipeline may be built in the present invention. In general, there may be a mapping of expected input and/or output types through a format specification mechanism, and/or the chaining together of analysis and/or supporting modules through a pipeline specification mechanism. These can be extensions of a command-line interface, API, graphical user interface, configuration-driven, and/or through an easy-to-use mechanism, such as a natural language processing system, whereby operators can configure and/or manage their deployments through natural language and/or through easy-to-use graphical user interfaces, such as node-based no-code editors.

FIG. 9 is an exemplary depiction that aims to simplify and clearly depict the general principles for configuring an analysis system. In general, there may be some analysis and/or supporting module, depicted as a Generic Analysis or Supporting Module (910). In FIG. 9, there are for example two such generic analysis and/or supporting modules, (910a) and (910b). Each may be associated with its own Input (913) and Output (917). Both the input and output correspond to Normalization Data (920), a known data type, at least one data type of a selection of data types, such as Intermediate Representations that may be intermediate representations from data structures (IR_{DS}), security policies (IR_{SP}), binary lifting (IR_{BL}), among others. Although the figure demonstrates a limited set of data types, the invention is not limited in the types and/or combinations of data it can support for various input and output specifications of analysis and supporting modules.

The exemplary form of this illustration is indicating the normalization data originates from a Configuration API (130). Normalization Data (920) of the exemplary form may be illustrating a generic Intermediate Representation, however, the present invention does not limit the type of normalized data in accordance with the essence for cooperation between modules. The origin of Normalization Data (920) is not limited to any source, this may apply to the storage, management, and access of this data, which is in accordance with the spirit of enabling cooperation between modules and the analysis of data and/or results derived from a multitude of modules. Another aspect of Normalization Data (920) is its form of storage. The present invention does not limit the type or form of storage which may be a database, spreadsheet, data structure, and/or other form that functions in the essence of a lookup to be utilized, configured, and amended flexibly for multiple purposes throughout a System (120) of the invention.

These may be configured through a Configuration API (130), which houses an Analysis Module Format Specification API (933) for formatting the input and/or output data types, a selection of at least one data type from a set of candidate data types, whereby module inputs and/or outputs may not only known but ensure compatibility with one another. Another key component may be an Analysis Module Pipeline Specification API (937), whereby the arrangement and/or order of the analysis and/or supporting modules may be defined to specify a deployment of a System (120) of the invention. The pipeline may be specified through various means, including but not limited to Command-Line Interface, UI/UX, and/or Domain-Specific Language.

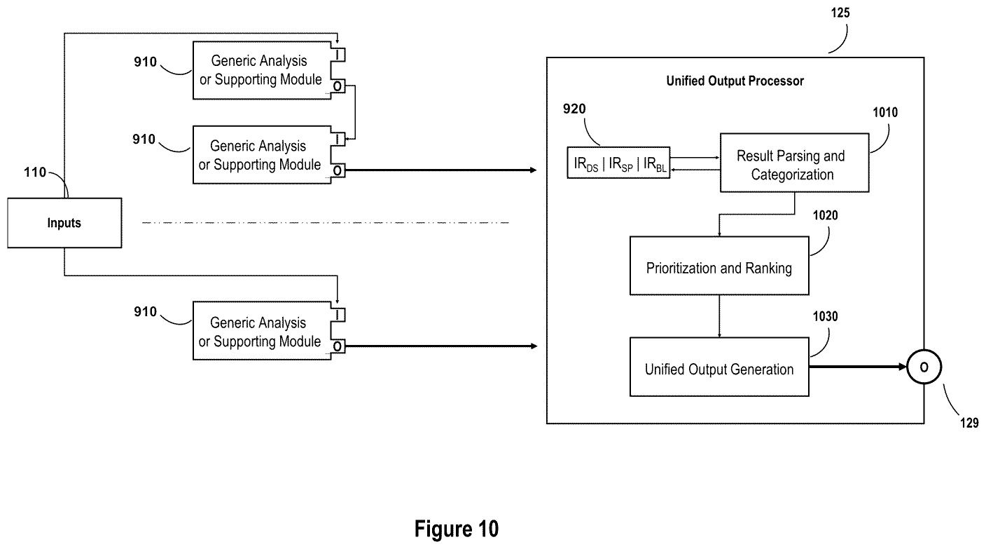

FIG. 10 illustrates an enhanced example of an analysis system's output processing mechanism, featuring a Unified Output Processor (125) that integrates and analyzes results from multiple Generic Analysis or Supporting Modules (910).

The figure shows three main example components:
Inputs (110): This represents the various data sources that feed into the analysis modules.
Generic Analysis or Supporting Modules (910): These modules perform specific types of analysis (e.g., source code analysis, binary analysis, policy analysis) on the input data. The figure shows for example but not limited to three such modules, demonstrating the system's ability to incorporate multiple analysis types.
Unified Output Processor (125): This may be the core component that integrates and processes the outputs from the various analysis modules.

Generic Analysis or Supporting Modules (910) are shown in two configurations:
Chained Configuration: The top two modules may be connected, indicating that the output of one module serves as input to another. This configuration allows for more complex, multi-stage analysis pipelines.
Individual Configuration: The bottom module operates independently, feeding its output directly into the Unified Output Processor.

Both configurations ultimately feed their results into the Unified Output Processor (125), which consists of several subcomponents:
Intermediate Representation (920): This component represents the normalized intermediate representations of results from different analysis types (e.g., DS for data structures, SP for security policies, BL for binary lifting). These normalized representations may be crucial for enabling consistent processing across diverse analysis outputs. This table may be created with the Configurations API (130) and accessed by the Unified Output Processor (125). Although shown as an internal copy, this table may be accessed flexibly. The invention is not opinionated about the storage, management, and access rules associated with the table, database, and/or data representing normalized data of analyses and support modules.
Result Parsing and Categorization (1010): This subcomponent takes the normalized intermediate representations and parses them into categorized findings. It organizes the results based on predefined criteria such as vulnerability type, severity, and/or affected system component.
Prioritization and Ranking (1020): After categorization, this subcomponent applies algorithms to prioritize and rank the findings. It considers factors such as severity, scope of impact, and potential correlations between findings from different analysis modules.
Unified Output Generation (1030): The final subcomponent synthesizes the prioritized and ranked findings into a comprehensive, unified output. This output provides a holistic view of the system's security status, highlighting critical vulnerabilities, cross-module correlations, and potential compound issues.

The Unified Output Processor's (125) final output may be represented by a global Output API (129), which delivers the consolidated, prioritized security analysis results.

It is important to note that while not explicitly shown in the diagram, an analysis system utilizes normalization representations and/or tables generated by the Configuration API (130) to inform its operations. These normalization rules ensure consistent interpretation and processing of diverse analysis outputs.

Although not depicted in FIG. 10, an analysis system may support a reinforcement mechanism that can provide feedback to the analysis modules and/or their subcomponents. This mechanism may use similar normalization techniques to ensure compatibility with the various modules and components of the system.

This unified approach to output processing enables an analysis system to provide more comprehensive, contextual, and actionable security insights than would be possible with isolated analysis tools. By correlating and prioritizing findings from multiple analysis types, an analysis system can identify complex vulnerabilities and provide a more accurate assessment of overall system security.

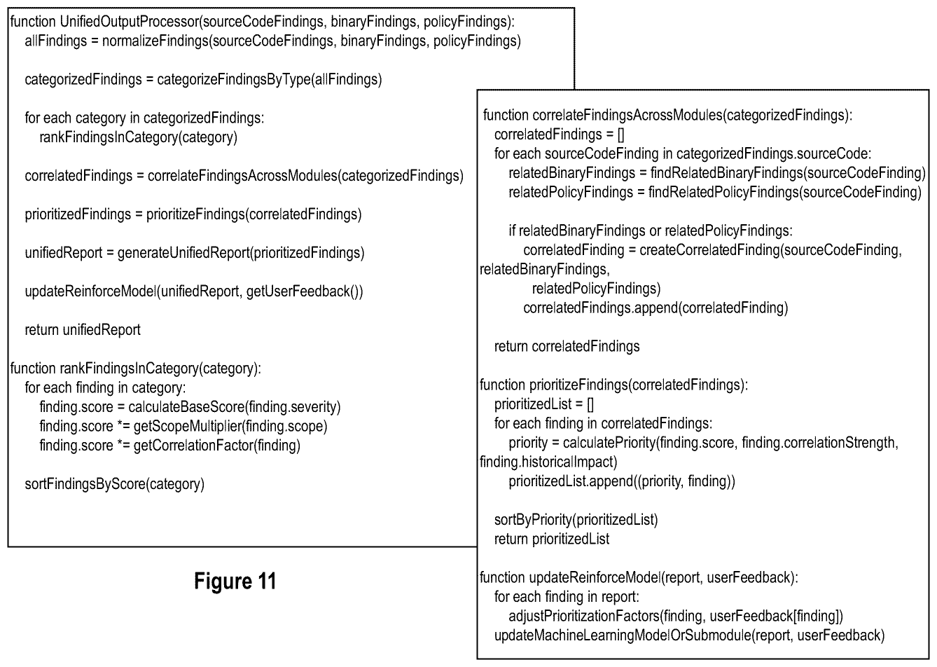

FIG. 11 illustrates pseudocode for an exemplary implementation of a Unified Output Processor (125) in the security analysis system. The pseudocode outlines a series of functions that collectively process and integrate findings from multiple analysis modules.

The main function, “UnifiedOutputProcessor”, takes as input the findings from various analysis modules, including but not limited to “sourceCodeFindings”, “binaryFindings”, and “policyFindings”. This function orchestrates the overall process of unifying and prioritizing the security analysis results.

The process begins with a call to “normalizeFindings”, which standardizes the diverse inputs into a consistent format. The normalized findings may be categorized by type using the “categorizeFindingsByType” function.

For each category of findings, the “rankFindingsInCategory” function may be called. This function assigns scores to individual findings based on factors such as severity, scope, and correlation with other findings. The findings within each category may be sorted based on these scores.

The “correlateFindingsAcrossModules” function identifies relationships between findings from different analysis modules. It iterates through source code findings and attempts to find related binary and policy findings, creating correlated finding objects when relationships may be identified.

The “prioritizeFindings” function takes the correlated findings and assigns a global priority to each. This prioritization considers the finding's score, the strength of its correlations, and its historical impact. The findings may be sorted based on this global priority.

The “generateUnifiedReport” function creates a comprehensive report from the prioritized findings, providing a holistic view of the system's security status.

Finally, the “updateReinforceModelOrSubmodule” function may be called, which incorporates user feedback to adjust prioritization factors and update a target of an analysis system that may be but not limited to a machine learning model and/or submodule, for example corrections to an analysis module similar to automated calibration, for future analyses.

The pseudocode concludes by returning the unified report.

Additional helper functions may be defined to support the main process:
“rankFindingsInCategory” calculates scores for findings within a category based on severity, scope, and correlation factors.
“correlateFindingsAcrossModules” identifies relationships between findings from different analysis types.
“prioritizeFindings” assigns global priorities to correlated findings.
“updateReinforceModel” adjusts the system's prioritization and machine learning models based on user feedback.

This algorithm demonstrates a flexible approach to unifying and prioritizing security findings from diverse analysis sources. It can be adapted to various types of security analyses and can incorporate different scoring methods, correlation techniques, and machine learning models as needed. It should be noted that this pseudocode is exemplary and non-limiting. The actual implementation may include additional functions, alternative logic flows, and/or different data structures while still embodying the core principles of the unified output processing method described herein.

### Examples

### Example 1: Speculative Execution Vulnerability Detection

### Scenario:

A complex target computing system is being analyzed using the integrated pipeline.

### Inputs:

Source code (from module 123b): Contains no explicit vulnerabilities related to speculative execution.
Binary analysis (from module 123c): Reveals low-level instructions that could potentially be exploited in a speculative execution attack.
Security policy (from module 123a): Indicates that the software may be intended for use in high-security environments.

Integrated Analysis, the system correlates these inputs through its pipeline:
The source code analysis does not flag any issues.
The binary analysis module identifies potentially exploitable instructions.
The security policy analysis highlights the high-security context.
The CI/CD amalgamation analysis (module 123g) combines these insights.

### Output:

The system flags a potential speculative execution vulnerability that would not have been apparent from any single analysis method. It recommends specific code changes and compiler optimizations to mitigate the risk.

### Benefit:

This example demonstrates how the integrated approach can identify subtle vulnerabilities that emerge from the interaction between high-level code, low-level binary instructions, and deployment context. This level of insight would not be obvious to someone skilled in traditional software security analysis, as it requires the correlation of multiple layers of information.

### Example 2: Network Operation Security in IoT Devices

### Scenario:

An IoT device's firmware is being analyzed for potential security vulnerabilities.

### Inputs:

Source code (from module 123b): Shows standard network operations without obvious vulnerabilities.
Binary analysis (from module 123c): Reveals use of an outdated cryptographic library.
Configuration file analysis (from module 123a): Indicates default settings that allow broad network access.
System behavior analysis (from module 123d): Shows unexpected network activity during certain operations.

Integrated Analysis, the pipeline processes these inputs:
Source code analysis does not flag major issues.
Binary analysis identifies the outdated library.
Configuration analysis highlights permissive network settings.
System behavior analysis detects anomalous network activity.
The software AI module (123e) correlates these findings.

### Output:

The system identifies a complex vulnerability where the combination of the outdated crypto library, permissive network settings, and unexpected network activity creates a significant security risk. It suggests updating the library, tightening network configurations, and investigating the cause of the anomalous network behavior.

### Benefit:

This example showcases how the integrated approach can uncover a security risk that emerges from the interaction of multiple factors across different layers of the software stack. This holistic view would not be apparent from any single analysis technique, demonstrating the non-obvious advantage of the integrated pipeline to someone skilled in the art.

### Example 3: Embedded Device Firmware Analysis

### Scenario:

Firmware for an embedded medical device is being analyzed for security vulnerabilities.

### Inputs:

Source code (from module 123b): Contains no obvious security flaws.
Binary analysis (from module 123c): Reveals potential buffer overflow in a rarely used function.
Security policy analysis (from module 123a): Indicates strict requirements for data privacy and integrity.
System behavior analysis (from module 123d): Shows intermittent, unexplained memory access patterns.

Integrated Analysis, the pipeline correlates these inputs:
Source code analysis passes without major flags.
Binary analysis identifies the potential buffer overflow.
Security policy analysis emphasizes the critical nature of the device.
System behavior analysis detects unusual memory patterns.
The software composition analysis (module 123b) and software AI (module 123e) modules correlate these findings.

### Output:

The system identifies a critical vulnerability where the buffer overflow, combined with the unusual memory access patterns, could lead to unauthorized access to sensitive patient data. This vulnerability is particularly severe given the strict security requirements for medical devices. The system recommends specific code changes, additional bounds checking, and a thorough review of memory management practices.

### Benefit:

This example demonstrates how the integrated approach can uncover a critical vulnerability that arises from the subtle interaction of code structure, binary-level flaws, and runtime behavior. The severity of this vulnerability is amplified by the specific context of medical devices, showcasing how the system's holistic analysis provides insights that would not be obvious from individual analysis techniques. This comprehensive view is particularly valuable for embedded systems where security flaws can have serious real-world consequences.

### Example 4: Cloud Service Configuration Vulnerability

### Scenario:

A large-scale cloud service application is being analyzed for security vulnerabilities.

### Inputs:

Source code (from module 123b): Shows secure coding practices with no obvious flaws.
Binary analysis (from module 123c): Reveals no significant issues in the compiled code.
Configuration file analysis (from module 123a): Indicates complex, multi-layer configuration settings for different environments.
CI/CD amalgamation analysis (from module 123g): Shows frequent configuration changes across development, staging, and production environments.
System behavior analysis (from module 123d): Detects occasional unexpected API calls in the production environment.

Integrated Analysis, the pipeline processes and correlates these inputs:
Source code and binary analyses pass without major flags.
Configuration analysis highlights the complexity of settings across environments.
CI/CD analysis shows the frequency of configuration changes.
System behavior analysis identifies anomalous API calls.
The software AI module (123e) correlates these findings with historical data.

### Output:

The system identifies a subtle but critical vulnerability where certain combinations of configuration settings, when propagated from development to production, can inadvertently expose internal APIs. This exposure is not apparent in any single environment but emerges due to the interaction of configurations across the deployment pipeline. The system recommends implementing stricter configuration validation processes, automated security checks for API exposure before deployment, and a review of the CI/CD pipeline to prevent potentially dangerous configuration combinations.

### Benefit:

This example showcases how the integrated approach can uncover vulnerabilities that exist not in the code itself, but in the complex interplay of configurations across different environments. This level of analysis goes beyond traditional security assessments and would not be obvious even to skilled DevOps professionals focusing on individual stages of the deployment process.

### Example 5: Time-of-Check to Time-of-Use (TOCTOU) Vulnerability in a Multi-Threaded Application

### Scenario:

A multi-threaded application for high-frequency trading is being analyzed for potential security and race condition vulnerabilities.

### Inputs:

Source code analysis (from module 123b): Shows thread-safe coding practices with no obvious concurrency issues.
Binary analysis (from module 123c): Reveals potential for instruction reordering by the CPU for optimization.
System behavior analysis (from module 123d): Detects rare occurrences of unexpected order of operations under high load.
Security policy analysis (from module 123a): Indicates strict requirements for data integrity and transaction atomicity.
Software AI module (123e): Analyzes patterns in the codebase and runtime behavior.

Integrated Analysis, the pipeline correlates these inputs:
Source code analysis does not flag any significant concurrency issues.
Binary analysis identifies potential for instruction reordering.
System behavior analysis detects rare anomalies in operation order.
Security policy analysis emphasizes the critical nature of operation atomicity.
The software AI module correlates these findings with known patterns of TOCTOU vulnerabilities.

### Output:

The system identifies a subtle TOCTOU vulnerability that only manifests under specific high-load conditions due to the combination of instruction reordering at the CPU level and the rare occurrence of unexpected operation orders. This vulnerability could potentially lead to race conditions that compromise transaction integrity. The system recommends implementing additional synchronization mechanisms, reviewing the use of memory barriers, and suggests specific code refactoring to ensure transaction atomicity even under extreme conditions.

### Benefit:

This example demonstrates the system's ability to identify extremely subtle vulnerabilities that emerge from the interaction of high-level code structure, low-level CPU behavior, and real-world operating conditions. This level of analysis combines insights from static code analysis, binary-level understanding, and dynamic behavior observation in a way that would not be obvious even to experts in concurrent programming. It showcases how the integrated approach can uncover potential issues that exist in the gaps between different layers of the software stack and different stages of the execution process.

### Example 6: Side-Channel Vulnerability in a Cryptographic Library

### Scenario:

A widely-used cryptographic library is being analyzed for potential vulnerabilities.

### Inputs:

Source code analysis (from module 123b): Shows well-implemented cryptographic algorithms with no obvious flaws.
Binary analysis (from module 123c): Reveals subtle variations in execution time for different input values.
System behavior analysis (from module 123d): Detects minor fluctuations in power consumption during key operations.
Security policy analysis (from module 123a): Indicates the library is intended for use in high-security applications.
Software AI module (123e): Analyzes patterns in execution time and power consumption data.

Integrated Analysis, the pipeline correlates these inputs:
Source code analysis passes without major flags.
Binary analysis identifies variations in execution time.
System behavior analysis detects power consumption fluctuations.
Security policy analysis emphasizes the critical nature of the library.
The software AI module correlates timing and power data with known side-channel attack patterns.

### Output:

An analysis system identifies a subtle side-channel vulnerability that could potentially leak key information through timing and power analysis. This vulnerability is not apparent in the source code or from analyzing any single aspect of the system. The integrated analysis reveals that the combination of slight timing variations and power fluctuations could be exploited in a sophisticated side-channel attack. An analysis system recommends implementing constant-time algorithms, adding noise to power consumption, and suggests specific code modifications to mitigate the risk.

### Benefit:

This example showcases the system's ability to uncover extremely subtle vulnerabilities that exist at the intersection of algorithmic implementation, hardware behavior, and physical characteristics. This level of analysis, combining insights from multiple domains, would not be obvious even to cryptography experts focusing on the mathematical soundness of the algorithms. It demonstrates how the integrated approach can identify potential security risks that emerge from the interaction of software with its physical execution environment.

### Example 7: Data Flow Vulnerability in a Microservices Architecture

### Scenario:

A complex microservices-based application for financial transactions is being analyzed for security vulnerabilities.

### Inputs:

Source code analysis (from module 123b): Shows secure coding practices in individual microservices.
Configuration file analysis (from module 123a): Reveals complex service-to-service authentication settings.
System behavior analysis (from module 123d): Detects occasional unexpected data flows between services under high load.
CI/CD amalgamation analysis (from module 123g): Shows frequent updates and redeployments of individual services.
Software composition analysis (module 123b): Identifies all external dependencies and their versions.

Integrated Analysis, the pipeline correlates these inputs:
Source code analysis of individual services doesn't flag major issues.
Configuration analysis highlights the complexity of inter-service authentication.
System behavior analysis identifies anomalous data flows.
CI/CD analysis shows the dynamic nature of the service ecosystem.
Software composition analysis provides context on external dependencies.
The software AI module (123e) correlates these findings with known microservices vulnerability patterns.

### Output:

An analysis system identifies a complex vulnerability where certain combinations of service updates, authentication configurations, and high-load conditions can lead to unauthorized data access between microservices. This vulnerability is not apparent when analyzing any single service or configuration, but emerges from the dynamic interaction of multiple services over time. An analysis system recommends implementing more robust service-to-service authentication, stricter data flow controls, and suggests specific changes to the CI/CD pipeline to ensure security checks across service boundaries during updates.

### Benefit:

This example demonstrates an analysis system's ability to uncover vulnerabilities that exist not within individual components, but in the complex interactions between multiple, dynamically updating services. This level of analysis goes beyond traditional security assessments of microservices architectures and would not be obvious even to experienced system architects. It showcases how the integrated approach can identify potential security risks that emerge from the dynamic nature of modern, distributed systems, considering factors like frequent updates, complex authentication schemes, and varying load conditions.

These examples further illustrate how the present invention provides unique insights by correlating data from multiple analysis techniques across different architectural patterns and execution environments. They showcase complex vulnerabilities that would likely be missed by traditional, siloed approaches to software security analysis. An analysis system's ability to connect insights across different layers of system architecture, deployment processes, and runtime behaviors demonstrates its non-obvious benefits to those skilled in the art of software security.

What is claimed is:

1. A method for analyzing at least one computing system to determine attributes of software within the computing system, the attributes including vulnerabilities, weaknesses, robustness, expected/unexpected behaviors, functional attributes, non-functional attributes, and/or configuration/misconfigurations, the method comprising:
loading, via a processor, from a data storage, a memory, or via a communication, or via a user entry through a user interface, at least one input data representing or pertaining to the at least one software of the computing system, the at least one input data comprising at least one data format of the at least one software, the at least one data format including code, configurations, and/or behavioral data;
loading, from the data storage, the memory, or via the communication, or via the user entry through the user interface, and executing, via the processor, at least two individual analyses on the at least one data format of the at least one software of the at least one input data;
generating, via the processor, an individual analysis result for each of the at least two individual analyses, each individual analysis result pertaining to a layer and/or data format of the software, and indicating an attribute pertaining to the at least one input data;
loading, from the data storage, the memory, or via the communication, or via the user entry through the user interface, and executing, via the processor, at least one multi-layer and/or multi-data format analysis on the individual analysis results of the at least two individual analyses by identifying at least one logical relationship between an attribute of a first one of the individual analysis results pertaining to one layer and/or data format, an attribute of a second one of the individual analysis results pertaining to a different layer and/or data format that is logically related to the attribute of the first one of the individual analysis results;
generating, via the processor, at least one multi-layer and/or multi-data format analysis result indicating an additional attribute being different from the attributes indicated by the first and second ones of the individual analysis results;
generating, via the processor, an output data describing the individual analysis results and/or the at least one multi-layer and/or multi-data format analysis result;
storing, via the processor, the at least one output data in the memory; and
determining, via the processor, if the at least one output data satisfies a predetermined condition, and if so, executing at least one action corresponding to the at least one output data on the computing system.

2. The method according to claim 1, wherein the at least one computing system comprises at least one of a No/Low-Code (NLC) application platform, information technology (IT) system, cloud system, artificial intelligence system, machine learning model, simulation, control system, edge device, embedded device, information technology device, operational technology (OT) device, industrial control system, cyber-physical system, headset, mobile device, tablet device, or robotics system.

3. The method according to claim 1, wherein the attributes comprise at least one of vulnerabilities, weaknesses, correctness, compliance, adherence to best practices, robustness, fairness, non-bias, transparency, interpretability, safety, security, reliability, accuracy, trust, explainability, privacy, or accountability.

4. The method according to claim 1, further comprising:
performing, by the processor, at least one of continuous integration and continuous deployment (CI/CD) DevOps/DevSecOps, testing, development, security analysis, evaluation, certification; and
determining a suspicious fault, violation of requirements, or vulnerability in the computing system during the performance of the at least one of CI/CD DevOps/DevSecOps, testing, development, security analysis, evaluation, certification, wherein
the at least one input data is loaded when the suspicious fault, violation of requirements, or vulnerability is determined.

5. The method according to claim 1, wherein the at least one input data comprises at least one of binary software, machine code software, Intermediate Representation (IR) software, Intermediate Language (IL) software, bytecode software, source code, No/Low-Code (NLC) configurations, and application configurations.

6. The method according to claim 1, wherein the at least two individual analyses include security policies and configurations analysis, binary analysis, artificial intelligence and machine learning (AI/ML) based analysis, software composition analysis, and system behavior analysis.

7. The method according to claim 1, wherein the at least one individual analysis result comprises at least one of vulnerability, weakness, absence of vulnerability, absence of weakness, mitigation recommendation, attacks, severity, and potential impact.

8. The method according to claim 1, wherein the at least one multi-layer analysis comprises identifying correlations across individual analysis results indicating additional results and detecting anomalies across individual analysis results indicating additional results.

9. The method according to claim 1, wherein the at least one input data is loaded once, multiple times, or on a continuous basis.

10. The method according to claim 1, further comprising analyzing the input data for unexpected data, inconsistencies, anomalies, or out-of-distribution data.

11. The method according to claim 1, wherein the at least one output data comprises at least one of an analysis report, user-readable analysis report, visualizations, suggestions, recommendations, scorecard, machine-readable analysis report, or application programming interface (API) call.

12. The method according to claim 1, wherein the at least one action comprises at least one of presenting output data to a user, communicating output data to another machine, storing output data, triggering one or more notifications or alarms, blocking functioning of a computing system, or triggering automated hardening of the computing system.

13. A system for analyzing at least one computing system to determine attributes of software within the computing system, the attributes including vulnerabilities, weaknesses, robustness, expected/unexpected behaviors, functional attributes, non-functional attributes, and/or configuration/misconfigurations, the system comprising:
a processor;
a memory or a data storage that stores data and a program;
a communication device that communicates with the at least one computing system; and
a user interface that receives a user entry, wherein
when the program is executed by the processor, the processor is caused to
load, from the data storage, the memory, or via the communication device, or via the user entry, at least one input data representing or pertaining to the at least one software of the computing system, the at least one input data comprising at least one data format of the at least one software, the at least one data format including code, configurations, and/or behavioral data;
load, from the data storage, the memory, or via the communication device, or via the user entry through the user interface, and execute at least two individual analyses on the at least one data format of the at least one software of the at least one input data;
generate an individual analysis result for each of the at least two individual analyses, each individual analysis result pertaining to a layer and/or data format of the software, and indicating an attribute pertaining to the at least one input data;
load, from the data storage, the memory, or via the communication device, or via the user entry through the user interface, and execute at least one multi-layer and/or multi-data format analysis on the individual analysis results of the at least two individual analyses by identifying at least one logical relationship between an attribute of a first one of the individual analysis results pertaining to one layer and/or data format, an attribute of a second one of the individual analysis results pertaining to a different layer and/or data format that is logically related to the attribute of the first one of the individual analysis results;
generate at least one multi-layer and/or multi-data format analysis result indicating an additional attribute being different from the attributes indicated by the first and second ones of the individual analysis results;
generate an output data describing the individual analysis results and/or the at least one multi-layer and/or multi-data format analysis result;
store the at least one output data in the memory; and
determine if the at least one output data satisfies a predetermined condition, and if so, execute at least one action corresponding to the at least one output data on the computing system.

14. The system according to claim 13, wherein the at least one computing system comprises at least one of a No/Low-Code (NLC) application platform, information technology (IT) system, cloud system, artificial intelligence system, machine learning model, simulation, control system, edge device, embedded device, information technology device, operational technology (OT) device, industrial control system, cyber-physical system, headset, mobile device, tablet device, or robotics system.

15. The system according to claim 13, wherein the properties attributes comprise at least one of vulnerabilities, weaknesses, correctness, compliance, adherence to best practices, robustness, fairness, non-bias, transparency, interpretability, safety, security, reliability, accuracy, trust, explainability, privacy, or accountability.

16. The system according to claim 13, wherein the processor is further configured to:
perform at least one of CI/CD DevOps/DevSecOps, testing, development, security analysis, evaluation, certification; and
determine a suspicious fault, violation of requirements, or vulnerability in the computing system during the performance of the at least one of continuous integration and continuous deployment (CI/CD) DevOps/DevSecOps, testing, development, security analysis, evaluation, certification, wherein
the at least one input data is loaded when the suspicious fault, violation of requirements, or vulnerability is determined.

17. The system according to claim 13, wherein the at least one input data comprises at least one of binary software, machine code software, Intermediate Representation (IR) software, Intermediate Language (IL) software, bytecode software, source code, No/Low-Code (NLC) configurations, and application configurations.

18. The system according to claim 13, wherein the at least two individual analyses include security policies and configurations analysis, binary analysis, artificial intelligence and machine learning (AI/ML) based analysis, software composition analysis, and system behavior analysis.

19. The system according to claim 13, wherein the at least one individual analysis result comprises at least one of vulnerability, weakness, absence of vulnerability, absence of weakness, mitigation recommendation, attacks, severity, and potential impact.

20. The system according to claim 13, wherein the at least one multi-layer analysis comprises identifying correlations across individual analysis results indicating additional results and detecting anomalies across individual analysis results indicating additional results.

21. The system according to claim 13, wherein the at least one input data is loaded once, multiple times, or on a continuous basis.

22. The system according to claim 13, wherein the processor is further configured to analyze the input data for unexpected data, inconsistencies, anomalies, or out-of-distribution data.

23. The system according to claim 13, wherein the at least one output data comprises at least one of an analysis report, user-readable analysis report, visualizations, suggestions, recommendations, scorecard, machine-readable analysis report, or application programming interface (API) call.

24. The system according to claim 13, wherein the at least one action comprises at least one of presenting output data to a user, communicating output data to another machine, storing output data, triggering one or more notifications or alarms, blocking the functioning of the computing system, or triggering automated hardening of the computing system.
